(19) United States
(12) Patent Application Publication
(10) Pub. No.: US 2026/0360733 A1
(43) Pub. Date: Nov. 12, 2026

(54) BATTERY CELL, BATTERY APPARATUS, ELECTRICAL APPARATUS, AND ENERGY STORAGE APPARATUS

(71) Applicant: CONTEMPORARY AMPEREX TECHNOLOGY CO., LIMITED, Ningde (CN)

(72) Inventors: Xinde Ye, Ningde (CN); Xiaofeng Zhang, Ningde (CN); Xiaoyang Jia, Ningde (CN); Jia Li, Ningde (FJ); Song Li, Ningde (CN); Tianyue Yuan, Ningde (CN)

(21) Appl. No.: 19/378,351

(22) Filed: Nov. 4, 2025

Related U.S. Application Data
(63) Continuation of application No. PCT/CN2025/094394, filed on May 12, 2025.

(51) Int. Cl. H01M 4/58; H01M 4/02; H01M 4/136; H01M 4/62; H01M 10/0525; H01M 10/0585; H01M 50/105; H01M 50/119; H01M 50/121; H01M 50/122; H01M 50/133; H01M 50/426; H01M 50/434; H01M 50/451; H01M 50/457; H01M 50/463

(52) U.S. Cl. CPC H01M 4/5825; H01M 4/136; H01M 4/625; H01M 10/0525; H01M 10/0585; H01M 50/105; H01M 50/119; H01M 50/121; H01M 50/122; H01M 50/133; H01M 50/426; H01M 50/434; H01M 50/451; H01M 50/457; H01M 50/463; H01M 2004/021; H01M 2004/028

(57) ABSTRACT

A battery cell, a battery apparatus, an electrical apparatus, and an energy storage apparatus are provided. The battery cell includes a stacked-type cell having a positive electrode plate and a negative electrode plate. The positive electrode plate includes a current collector and a positive electrode film layer disposed on at least one side of the current collector, the film layer including lithium-containing transition metal phosphate particles with at least part of the surface coated by carbon. When fully discharged, the compacted density of the positive electrode plate is 2.3-2.6 g/cm³, and the single-side surface density of the film layer is 0.25-0.45 g per 1540.25 mm². In a cumulative sphericity-area distribution of particles ≥1000 nm, LR1A50 is 0.6-0.8. In a cumulative distribution of graphitization degree measured by confocal Raman spectroscopy, median C50 is 0.95-1.20. The battery cell exhibits high capacity and good cycling performance.

### CROSS-REFERENCE TO RELATED APPLICATIONS

This application is a continuation of International Patent Application No. PCT/CN2025/094394 filed on May 12, 2025, the content of which is incorporated herein by reference in its entirety.

### TECHNICAL FIELD

The present application relates to the technical field of batteries, and in particular to a battery cell, a battery apparatus, an electrical apparatus and an energy storage apparatus.

### BACKGROUND

In recent years, battery cells have been widely used in energy storage power systems such as hydropower, thermal power, wind power and solar power stations, as well as the fields of power tools, electric bicycles, electric motorcycles, electric vehicles, military equipment, aerospace and other fields.

With the pursuit of battery's range and service life in the market, higher requirements are put forward for battery capacity and cycling performance. However, it is difficult to achieve simultaneous improvement of the above-mentioned performances with existing technologies, and how to balance the two has become a technical problem that urgently needs to be solved in this field.

### SUMMARY OF THE INVENTION

The present application is conducted in view of the above issues, and aims to provide a battery cell with high capacity and good cycling performance.

According to a first aspect of the present application, a battery cell is provided. The battery cell includes a stacked type cell, the stacked type cell includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with at least part of the surface provided with a carbon material; when the battery cell is fully discharged, a compacted density of the positive electrode plate is 2.3 g/cm³ to 2.6 g/cm³; a single-side surface density of the positive electrode film layer is 0.25 g/1540.25 mm² to 0.45 g/1540.25 mm²; in a cross-section of the positive electrode film layer along a thickness direction of the positive electrode plate, in a cumulative distribution curve of sphericity area of particles with a particle size R1 satisfying R1≥1000 nm, L_{R1A50} is 0.6-0.8; and in a cumulative distribution curve of graphitization degree C value of the positive electrode film layer obtained in a surface scanning mode of a laser microscopic confocal Raman spectrometer, the median C₅₀ of the graphitization degree is 0.95-1.20; wherein the graphitization degree C value is I_{G}/I_{D}, I_{G} represents the intensity of G-band of the Raman spectrum at 1580±100 cm⁻¹, and I_{D} represents the intensity of D-band of the Raman spectrum at 1350±100 cm⁻¹.

Studies have shown that the stress concentration area of the film layer is prone to cracking under the action of cyclic expansion, becoming the starting point for film layer peeling-off, which is more significant in thick-coated battery cells. Compared with ternary materials, lithium-containing transition metal phosphates have a more stable structure and are less likely to break under high pressure. During the electrode plate compaction process, lithium-containing transition metal phosphates need to withstand higher pressures so as to increase the compacted density. However, when the battery cell is fully discharged, the compacted density of the positive electrode plate being greater than 2.6 g/cm³ will cause the electrode plate to be over-pressed, aggravate stress concentration, and increase the risk of film layer peeling-off during cycling; while the compacted density of the positive electrode plate being less than 2.3 g/cm³ will make the contact degree of the positive electrode film layer particles insufficient, resulting in increased internal resistance of the battery and affecting the energy density of the battery cell; the single-side surface density of the positive electrode film layer being lower than 0.25 g/1540.25 mm² cannot meet the requirements of high energy density; and the single-side surface density of the positive electrode film layer being higher than 0.45 g/1540.25 mm² will make the positive electrode film layer too thick, then the volume expansion during cycling is significant, stress concentration is aggravated, and the risk of film layer peeling-off is increased.

Stacked type cells are beneficial to improving the space utilization of batteries, thereby further increasing the volumetric energy density of battery cells and increasing battery capacity. The applicant has found that in thick-coated stacked type cells, stress concentration usually originates from local stress generated during the compaction process. On the one hand, during the compaction process, the force-bearing surface of particles with low sphericity is sharp and the sliding friction increases during the compaction process, which is more likely to cause stress concentration; and lithium-containing transition metal phosphate particles often require high-temperature sintering. With the melting of grain boundaries and the growth of particles, the sphericity of the particles will decrease, and the median sphericity of the particles will often not exceed 0.8. In the cross-section of the positive electrode film layer along the thickness direction of the positive electrode plate, in the cumulative distribution curve of sphericity area of particles with a particle size R1 satisfying R1≥1000 nm, when the L_{R1A50} is less than 0.6, a large local stress will be generated in the particles during the compaction process, and the risk of film layer peeling-off during cycling will increase significantly; on the other hand, the median C₅₀ of the graphitization degree reflects the degree of order in the carbon material layer. When the graphitization degree is higher than 1.2, its concentration degree is low. Therefore, considering the uniformity of the material, the graphitization degree of the carbon material layer is usually not higher than 1.2. When C₅₀ is less than 0.95, the slippage of the carbon layer structure is reduced, resulting in large friction between particles during compaction and making slippage difficult, further increasing the stress during the compaction process, thereby increasing the probability of film layer peeling-off during cycling.

The battery cell provided in the present application adopts a process involving thick coating and stacked type cell, and controls the compacted density of the positive electrode plate to be 2.3 g/cm³ to 2.6 g/cm³ when the battery cell is fully discharged; the single-side surface density of the positive electrode film layer is 0.25 g/1540.25 mm² to 0.45 g/1540.25 mm², thereby alleviating stress concentration, reducing the probability of film layer peeling-off, and improving the cycle life of the battery while improving the battery capacity; further, by controlling the L_{R1A50} in the cumulative distribution curve of sphericity area of particles with a particle size R1 satisfying R1≥1000 nm in the cross-section of the positive electrode film layer along the thickness direction of the electrode plate to be 0.6-0.8, and controlling the median value C₅₀ of the graphitization degree in the cumulative distribution curve of graphitization degree C value of the positive electrode film layer obtained in the surface scanning mode of the laser microscopic confocal Raman spectrometer to be 0.95-1.20, the sphericity of large particles in the positive electrode film layer and the graphitization degree of the positive electrode film layer are improved, thereby improving the local stress generated during the compaction process, further reducing the probability of film layer peeling-off and improving the cycle life of the battery.

In summary, the battery cell of the present application has good capacity while improving its capacity diving problem, and taking into account the cycle life of the battery.

In any embodiment, the single-side coating surface density of the positive electrode film layer is 0.3 g/1540.25 mm²-0.45 g/1540.25 mm².

In any embodiment, the single-side coating surface density of the positive electrode film layer is 0.35 g/1540.25 mm²-0.4 g/1540.25 mm².

The single-side coating surface density of the positive electrode film layer being further within the above range helps to further improve the capacity of the battery while taking into account the cycling performance.

In any embodiment, in the cumulative distribution curve of graphitization degree C value of the positive electrode film layer obtained in the surface scanning mode of the laser microscopic confocal Raman spectrometer, the median value C₅₀ of the graphitization degree is 1.01-1.13.

The graphitization degree of the positive electrode film layer being further within the above range helps to further improve the slippage of particles in the positive electrode film layer, reduce stress concentration in the positive electrode film layer, and thus further improve the long-cycle stability of the battery cell.

In any embodiment, in the cross-section of the positive electrode film layer along the thickness direction of the positive electrode plate, in the cumulative distribution curve of sphericity of particles with a particle size R1 satisfying R1≥1000 nm, L_{R1A50} is 0.65-0.75.

In any embodiment, in the cross-section of the positive electrode film layer along the thickness direction of the positive electrode plate, in the cumulative distribution curve of sphericity of particles with a particle size R1 satisfying R1≥1000 nm, L_{R1A50} is 0.67-0.72.

In the cross-section of the positive electrode film layer along the thickness direction of the positive electrode plate, in the cumulative distribution curve of sphericity area of particles with a particle size R1 satisfying R1≥1000 nm, L_{R1A50} is in the range of 0.65-0.75, and further in the range of 0.67-0.72, which is beneficial to further reducing the stress concentration at large particles in the positive electrode film layer of the thick-coated stacked type cell, thereby reducing the probability of film layer peeling-off and improving the cycle life of the battery.

In any embodiment, the single-side thickness H of the positive electrode film layer is 70 μm to 120 μm.

In any embodiment, the single-side thickness H of the positive electrode film layer is 90 μm to 120 μm.

The single-side thickness of the positive electrode film layer being within the above range helps to increase the loading amount of the positive electrode active material in the battery, thereby increasing the capacity of the battery.

In any embodiment, the single-side thickness H of the positive electrode film layer is 100 μm to 120 μm.

Increasing the thickness of the positive electrode film layer helps to increase the loading amount of the positive electrode active material and helps to increase the capacity of the battery. However, the applicant found that when the single-side thickness of the positive electrode film layer is greater than or equal to 100 μm, during cycling of the battery, the volume expansion of the positive electrode film layer is more significant, thereby generating greater stress, the stress concentration phenomenon in the positive electrode film layer is more significant, and the risk of film layer peeling-off increases, thereby affecting the cycling performance of the battery. The embodiments of the present application increase the capacity of the battery by increasing the thickness of the positive electrode film layer, and at the same time controls the sphericity of particles with a particle size R1 satisfying R1≥1000 nm in the cross-section of the positive electrode film layer along the thickness direction of the positive electrode plate, and the median value C₅₀ of the graphitization degree in the cumulative distribution curve of graphitization degree C value of the positive electrode film layer obtained in the surface scanning mode of the laser microscopic confocal Raman spectrometer to increase the slippage degree between particles in the positive electrode film layer and reduce the stress concentration generated during the compaction process of the electrode plate, thereby increasing the battery capacity while taking into account the cycling performance of the battery. In any embodiment, based on the total area of particles in the cross-section of the positive electrode film layer along the thickness direction of the electrode plate, the area of particles with a particle size R1 satisfying R1≥1000 nm accounts for 12% to 50%.

In any embodiment, based on the total area of particles in the cross-section of the positive electrode film layer along the thickness direction of the electrode plate, the area of particles with a particle size R1 satisfying R1≥1000 nm accounts for 12%-40%.

Large particles with a particle size R1 satisfying R1≥1000 nm help to increase the compacted density of the positive electrode plate, thereby increasing the volumetric energy density of the battery cell; however, researchers have found that these large particles are prone to inducing stress concentration, increasing the risk of peeling-off of the positive electrode film layer. Therefore, the area proportion of particles with a particle size R1 satisfying R1≥1000 nm in the cross-section of the positive electrode film layer along the thickness direction of the electrode plate being in the range of 12% to 50%, further in the range of 12%-40% not only can improve the compacted density of the electrode plate, but also can prevent the probability of film layer peeling-off from being too high, thereby improving the energy density of thick-coated lithium-containing transition metal phosphate batteries while alleviating the capacity diving problem and taking into account the cycle life of the battery.

In any embodiment, the distribution uniformity of particles with a particle size R1 satisfying R1≥1000 nm in the cross-section of the positive electrode film layer along the thickness direction of the electrode plate is less than or equal to 5%.

In any embodiment, the distribution uniformity of particles with a particle size R1 satisfying R1≥1000 nm in the cross-section of the positive electrode film layer along the thickness direction of the electrode plate is 0.2% to 2.5%.

In any embodiment, the distribution uniformity of particles with a particle size R1 satisfying R1≥1000 nm in the cross-section of the positive electrode film layer along the thickness direction of the electrode plate is 0.2%-2%.

The distribution uniformity of particles with a particle size R1 satisfying R1≥1000 nm in the cross-section of the positive electrode film layer along the thickness direction of the electrode being within the above range can effectively reduce the stress concentration in local regions of the film layer, so that the stress in the compaction process of the film layer can be evenly distributed in the whole area of the film layer, thereby increasing the energy density of the battery while reducing the probability of film layer peeling-off, alleviating the capacity diving problem of thick-coated lithium-containing transition metal phosphate batteries, and improving the cycle life of the battery.

In any embodiment, in a cumulative distribution curve of coating value B of the positive electrode film layer obtained in the surface scanning mode of the laser microscopic confocal Raman spectrometer, the median B₅₀ of the coating value is 0.30-0.60, wherein the coating value B is I_{P}/I_{D}, I_{P} represents the intensity of P-band of the Raman spectrum at 948±100 cm⁻¹, and I_{P} represents the intensity of D-band of the Raman spectrum at 1350±100 cm⁻¹.

The median B₅₀ of the coating value of the positive electrode film layer being within the above range indicates that the carbon material layer of the positive electrode active material is relatively dense and uniform, which is beneficial to improving the slippage uniformity of the positive electrode film layer during rolling and reducing the stress concentration phenomenon in the thick-coated positive electrode film layer; in addition, with the help of the dense and uniform carbon material layer, the large particles in the positive electrode film layer are easier to slip during the compaction process, thereby reducing the stress concentration phenomenon at the large particles in the thick-coated positive electrode film layer, reducing the probability of peeling-off of the positive electrode film layer, improving the battery capacity diving problem, and increasing the cycle life of the battery.

In any embodiment, the lithium-containing transition metal phosphate particle in the positive electrode film layer includes a component represented by the following general formula:

LiₘFeₓP_{y}OⱼQ_{q} Formula I,

wherein Q includes one or more of Al, Na, K, Mg, Cu, Mn, Cr, Zn, Pb, Ca, Co, Ni, Sr, Nb, V, Ti, B, S, Si, N, F, Cl and Br; 0.8≤m≤1.15, 0.9≤x≤1, 0.95≤y≤1, 3.5≤j≤4, and 0≤q≤0.1.

In any embodiment, the lithium-containing transition metal phosphate particle in the positive electrode film layer includes one or more of lithium iron phosphate, lithium manganese phosphate, lithium vanadium fluorophosphate, lithium iron manganese phosphate and modified materials thereof.

In any embodiment, the lithium-containing transition metal phosphate particle in the positive electrode film layer includes one or more of lithium iron phosphate, doping modified material thereof, and coating modified material thereof.

In any embodiment, the iron dissolution rate of the positive electrode material is 658 ppm to 1921 ppm.

In any embodiment, the iron dissolution rate of the positive electrode material is 658 ppm to 1485 ppm.

In any embodiment, the mass content of titanium element is 500 ppm to 8000 ppm based on the total mass of the lithium-containing transition metal phosphate particles in the positive electrode film layer.

In any embodiment, the mass content of titanium element is 1000 ppm to 3000 ppm based on the total mass of the lithium-containing transition metal phosphate particles in the positive electrode film layer.

The introduction of titanium element into the lithium-containing transition metal phosphate particles requires the addition of a titanium source during the preparation of the positive electrode active material. Titanium sources are often inert materials, which can reduce the reaction activity and particle size growth by adhering to the surface of the lithium-containing transition metal phosphate material. Increasing the graphitization degree of the positive electrode active material often requires a high sintering temperature or a long sintering time, but this will also increase the size of the particles in the positive electrode film layer, increase the stress concentration of the positive electrode film layer, and cause peeling-off of the positive electrode film layer. In the embodiments of the present application, a high content of titanium element is added to the lithium-containing transition metal phosphate particles, so that the reactivity of the raw materials for synthesizing the positive electrode active material is reduced, and the positive electrode active material can achieve the control over the proportion of large particles while having a high graphitization degree, thus reducing stress concentration in the positive electrode film layer, reducing the probability of peeling-off of the positive electrode film layer, and improving the energy density of the battery while taking into account the cycle life of the battery.

At the same time, the doping of titanium element in the positive electrode active material is beneficial to causing lattice distortion, reducing Li—O bond energy, increasing lithium ion transmission rate, and improving the kinetic performance of the battery. The lithium ion diffusion in the thick coating film layer is uneven, often accompanied by a significant lithium ion concentration gradient. The embodiments of the present application improve the solid-phase transmission rate of the positive electrode active material by adding a high content of titanium element to the lithium-containing transition metal phosphate particles, thereby improving the kinetic problems of thick electrode plate batteries.

In any embodiment, the mass content of vanadium element is 500 ppm to 5000 ppm based on the total mass of the lithium-containing transition metal phosphate particles in the positive electrode film layer.

In any embodiment, the mass content of vanadium element is 500 ppm to 3000 ppm based on the total mass of the lithium-containing transition metal phosphate particles in the positive electrode film layer.

The vanadium element in the positive electrode film layer can be in multiple valence states. Among them, vanadium with a valence of +5 (V⁵⁺) can be doped at the phosphorus element site. Due to its large radius, it can cause lattice distortion and expand the diffusion channel of lithium ions, thereby improving the ionic conductivity of the positive electrode active material and improving the kinetic performance of the battery; vanadium with a valence of +3 (V³⁺) can be doped at the transition metal site to generate lithium holes through charge compensation, thereby improving the electronic conductivity of the positive electrode active material. In addition, the improved distribution uniformity of vanadium element in the lithium-containing transition metal phosphate particles helps to further improve the kinetic performance and reaction uniformity of the positive electrode film layer, thereby further improving the kinetic performance and cycling performance of the battery cell.

The mass content of vanadium element being within the above range helps to improve the kinetic performance of the positive electrode plate and the kinetic performance of the thick-coated lithium-containing transition metal phosphate battery. At the same time, the synergistic effect of titanium element, vanadium element and carbon nanotubes in the positive electrode film layer helps to form a good three-dimensional network, further improving the electronic conductivity and ionic conductivity of the positive electrode film layer, thereby further improving the kinetic performance of the thick-coated lithium-containing transition metal phosphate battery.

In any embodiment, the porosity of the negative electrode film layer is 14% to 28%.

The porosity of the positive electrode film layer being within the above range and the positive electrode film layer having good electrolyte solution infiltration rate and tortuosity is conducive to the diffusion of lithium ions in liquid and solid phases, helps to reduce the concentration polarization of the thick electrode plates, and improves the kinetic performance of the battery. At the same time, it helps to alleviate the volume expansion of the thick-coated electrode plates during cycling, reduce the mechanical stress of the film layer and reduce the stress concentration phenomenon, thereby reducing the risk of film layer peeling-off-off of the thick-coated electrode plates.

Especially in thick-coated pouch batteries, the gap between the case and the electrode plate is small, the volume occupancy of the film layer is large, the electrolyte solution holding volume is reduced, and the porosity of the positive electrode film layer is within the above range, which helps to improve the liquid retention rate of the battery cell and improve the kinetic performance of the battery.

In any embodiment, the positive electrode film layer further includes a conductive agent, and based on a total area of the cross-section of the positive electrode film layer along the thickness direction of the electrode plate, the area of an agglomeration region of the conductive agent accounts for 0.5% to 2.5%.

Based on the total area of the cross-section of the positive electrode film layer along the thickness direction of the electrode plate, the area proportion of the agglomeration region of the conductive agent being within the above range indicates that the conductive agent is evenly dispersed in the positive electrode film layer and is easy to form a uniform conductive network, which is particularly beneficial to reducing the problem of kinetic performance degradation caused by an increase in ion transmission path in the thick coating film layer, reducing the local polarization and even lithium plating problems generated in the battery during cycling, and improving the cycle life of the battery.

At the same time, studies have shown that large-sized first particles in the lithium-containing transition metal phosphate particles are prone to rebound. The agglomeration area of the conductive agent being within the above range can suppress the rebound of the lithium-containing transition metal phosphate particles with the help of the uniform distribution of the conductive agent, form mechanical constraints on the particles and even on the film layer, improve the cohesion of the film layer, reduce the phenomenon of powder falling-off and peeling-off of the film layer, and improve the cycle life of the battery.

In any embodiment, the positive electrode film layer further includes a conductive agent, and based on a total area of the cross-section of the positive electrode film layer along the thickness direction of the electrode plate, the area of an agglomeration region of the conductive agent accounts for 0.5% to 1.7%.

In the embodiments of the present application, the area proportion of the agglomeration region of the conductive agent being further within the above range indicates that the conductive agent is more evenly distributed in the positive electrode film layer, and the content of the conductive agent is relatively low. While improving the kinetic performance of the positive electrode film layer, it helps to reduce the space of the positive electrode active material occupied by excessive conductive agent, thereby further improving the volumetric energy density of the battery while improving the kinetic performance of the battery.

In any embodiment, the conductive agent includes carbon nanotubes, and the carbon nanotubes include one or more of single-walled carbon nanotubes, few-walled carbon nanotubes, and multi-walled carbon nanotubes.

Since carbon nanotubes have a one-dimensional structure, they can form a network structure in the positive electrode film layer. On the one hand, the high elastic modulus of carbon nanotubes enables its network structure not only to serve as a bridge for stress transmission, but also to constrain the thick-coated positive electrode film layer, inhibiting the rebound of the lithium-containing transition metal phosphate particles, effectively alleviating stress concentration, reducing the risk of film layer peeling-off, and thus improving the problem of battery capacity diving; on the other hand, the excellent conductivity of carbon nanotubes makes its network structure be an efficient electron transmission channel. Even if there is local film layer peeling-off, the thick electrode plate can still maintain high electron transmission efficiency in the in-plane direction and the thickness direction, thereby delaying the occurrence of the capacity diving problem and further improving the kinetic performance and cycle life of the battery.

In any embodiment, the conductive agent further includes conductive carbon black.

Conductive carbon black has a high specific surface area and thus has good liquid retention capacity. The thick electrode plate has a large expansion force during cycling, which makes the electrolyte solution easy to be squeezed out. The distribution of conductive carbon black in the positive electrode film layer is conducive to improving the liquid retention capacity of the thick electrode plate, further alleviating the phenomenon of battery capacity diving during cycling, and improving the cycle life of the battery.

In any embodiment, the agglomeration region of the conductive agent includes carbon nanotubes and conductive carbon black.

Researchers found that carbon nanotubes are prone to agglomeration due to their high surface energy, resulting in uneven dispersion in the positive electrode film layer and the inability to form an effective carbon nanotube network structure. The surface energies of conductive carbon black and carbon nanotubes are relatively close, allowing the carbon black to be adsorbed on the surface of carbon nanotubes and form a physical barrier, which increases the resistance to carbon nanotube agglomeration and reduces direct contact between carbon nanotubes, thereby inhibiting agglomeration and improving the distribution uniformity of carbon nanotubes in the positive electrode film layer. On the one hand, this helps to improve the conductivity of the thick-coated positive electrode film layer and improve the kinetic performance of the battery; on the other hand, it helps to enhance the constraining effect of carbon nanotubes on the positive electrode film layer, reduce the risk of peeling-off of the thick-coated positive electrode film layer, and further improve the kinetic performance and cycle life of the battery. In addition, the agglomeration of carbon nanotubes in the agglomeration region of the conductive agent will also lead to blockage of local ion transmission pathways in the agglomeration region of the conductive agent. The combination of conductive carbon black can improve the lithium ion transmission capacity of this region, reduce local polarization, and further improve the cycle stability of the battery.

In any embodiment, based on the mass of the positive electrode film layer, the mass content C1 of the carbon nanotubes satisfies: 0<C1≤2.5%, and the mass content C2 of the conductive carbon black satisfies: 0<C2≤2.5%.

The mass contents of carbon nanotubes and conductive carbon black being within the above ranges can effectively alleviate the agglomeration phenomenon of carbon nanotubes and form a good conductive network structure, thereby effectively reducing the stress concentration of the positive electrode film layer, and improving the liquid retention rate of the positive electrode plate during long cycles, further reducing the risk of peeling-off of the electrode plate film layer and the polarization degree, improving the kinetic performance of the battery while taking into account the capacity diving problem, and improving the cycle life of the battery.

In any embodiment, the positive electrode film layer further includes a dispersant, and the dispersant includes hydrogenated nitrile butadiene rubber (HNBR).

HNBR is obtained by hydrogenating nitrile butadiene rubber to saturate double bonds. Its highly saturated main chain structure makes it have excellent oil resistance, heat resistance and aging resistance. This allows it to remain stable in different environments and systems when used as a dispersant, and it is not easy to degrade or deteriorate, thereby effectively exerting its dispersing effect. HNBR molecular chain contains both polar nitrile groups and non-polar hydrocarbon segments. The polar nitrile group can interact with some polar substances or particle surfaces, such as being adsorbed on the surface of dispersed particles through hydrogen bonds, electrostatic effects, etc.; the non-polar hydrocarbon chain segments have good lipophilicity and can stretch and disperse well in a non-polar or weakly polar medium, so that the particles are evenly dispersed in the medium.

When HNBR is adsorbed on the surface of particles in a slurry, its long-chain molecules will form a physical barrier around the particles, preventing the particles from approaching and aggregating with each other, so that the particles remain relatively independent and dispersed in the system. At the same time, HNBR can reduce the surface tension between the dispersion medium and the dispersed particles, making the particles easier to be wetted by the medium, thereby promoting the dispersion of the particles in the medium. At the same time, it can also reduce the interfacial energy between particles and reduce the aggregation of particles driven by interfacial energy. Furthermore, when the slurry dries to form a film, the elastic network structure of HNBR can buffer the shrinkage stress caused by solvent volatilization, reduce the re-aggregation of the conductive agent due to capillary force in this process, reduce the area proportion of the agglomeration region of the conductive agent, and improve the kinetic performance and cycle life of the battery.

In any embodiment, based on the mass of the positive electrode film layer, the mass content of the dispersant is 0.5% to 2%.

The mass content of the dispersant being within the above range can achieve uniform dispersion of particles in the positive electrode film layer while maintaining a high loading amount of the positive electrode film layer, reduce stress concentration in the thick-coated lithium-containing transition metal phosphate positive electrode film layer, and effectively alleviate the capacity diving problem of the battery.

In any embodiment, the battery cell also includes a separator arranged between the positive electrode plate and the negative electrode plate, the separator includes a base film as well as a ceramic layer arranged on at least one side of the base film and an adhesive layer arranged on the side of at least one ceramic layer away from the base film, the adhesive layer is a continuous layer with a porous structure, and the adhesive layer includes a vinylidene fluoride-based polymer.

In any embodiment, the battery cell also includes a separator arranged between the positive electrode plate and the negative electrode plate, and the separator includes a base film as well as ceramic layers arranged on both sides of the base film and adhesive layers arranged on the side of each of the ceramic layers away from the base film.

In any embodiment, the vinylidene fluoride-based polymer includes one or more of polyvinylidene fluoride (PVDF) and polyvinylidene fluoride-hexafluoropropylene copolymer (PVDF-HFP).

In any embodiment, the vinylidene fluoride-based polymer includes polyvinylidene fluoride (PVDF).

In the prior art, the adhesive layer of the separator usually uses water-based PVDF, which presents an island-like structure in the separator. On the one hand, this is conducive to providing gaps for the expansion of the battery cell, and on the other hand, it is easy to manufacture; however, the contact area between the adhesive layer of such separator and the electrode plate is small, and the adhesive force is weak.

The separator provided in the embodiments of the present application uses a continuous layer with a porous structure as the adhesive layer, where its porous structure provides space for the expansion of the thick-coated battery cell, thereby improving the stability. At the same time, compared with the adhesive layer in the prior art, its adhesive area with the electrode plate is larger, thereby making the adhesion between the separator and the electrode plate more firm and uniform. Furthermore, when the positive electrode film layer rebounds, it is beneficial to maintaining the interface contact between the separator and the positive electrode film layer, thereby reducing the probability of film layer peeling-off.

Compared with wound battery cells, the compression between the separator and the electrode plate in the stacked type cell is small, and the separator and the electrode plate are prone to relative displacement, which causes disturbance to the film layer, leading to powder falling-off or peeling-off of the film layer; in addition, it may also cause the positive and negative electrodes to overlap with each other, increasing the risk of internal short circuit in the battery cell. Therefore, the separator provided in the embodiments of the present application is particularly suitable for stacked type cells. The increased adhesive force between the porous adhesive layer and the electrode plate helps to improve the adhesive force between the separator and the electrode plate and reduce the relative displacement between the separator and the electrode plate. This helps to reduce the disturbance to the positive electrode film layer and the probability of film layer peeling-off, and also helps to reduce the risk of overlap between positive and negative electrodes which would cause short circuit of the battery cell.

In summary, when the vinylidene fluoride-based polymer in the adhesive layer of the embodiments of the present application is selected from the above materials, it helps to form a continuous and uniform porous adhesive layer. First, the adhesive force between the adhesive layer and the electrode plate is improved and evenly distributed, which helps to reduce the stress concentration phenomenon in the thick-coated lithium-containing transition metal phosphate positive electrode film layer and reduce the risk of film layer peeling-off, thereby helping to further improve the cycle life of the battery; secondly, the adhesive layer is stably adhered to the positive electrode plate or the negative electrode plate, which helps to reduce the direct contact between the positive electrode plate and the negative electrode plate due to the relative displacement between the electrode plate and the separator, reduces the risk of internal short circuit, and helps to improve the safety performance of the battery; thirdly, the porous adhesive layer helps to maintain the porosity of the separator, reserves space for the expansion of the battery cell, and further improves the cycle life of the battery.

In any embodiment, the thickness of the base film in the separator is 7-9 μm.

In any embodiment, the single-side thickness of the ceramic layer in the separator is 2-4 μm.

In any embodiment, the single-side thickness of the adhesive layer in the separator is 1-5 μm.

If the thickness of the adhesive layer is too low, the void space in the separator will be small, and the adhesive force between the separator and the electrode plate will be low. On the one hand, the stress increases after the film layer expands, and the probability of film layer peeling-off increases, affecting the cycle life of the battery; on the other hand, the probability of short circuit due to the overlap between positive and negative electrode plates increases, thereby affecting the safety performance of the battery. If the thickness of the adhesive layer is too large, it will occupy a large space of the battery, thereby affecting the volumetric energy density of the battery. In the embodiments of the present application, the thickness of the adhesive layer being within the above range helps to take into account the cycle life, safety performance and volumetric energy density of the battery.

In any embodiment, the positive electrode film layer is provided with a primer layer at the bottom region close to the positive electrode current collector, the primer layer including a conductive agent and a binder, the conductive agent including carbon nanotubes and conductive carbon black, and the binder including polyvinylidene fluoride (PVDF).

In any embodiment, the thickness of the primer layer is 0.5 μm to 5 μm.

The primer layer provided in the embodiments of the present application helps to improve the adhesive force between the positive electrode film layer and the positive electrode current collector and alleviate the stress concentration phenomenon at large particles, thereby reducing the probability of peeling-off of the positive electrode film layer and improving the cycle stability of the battery. At the same time, compared with the direct contact between the positive electrode current collector and the positive electrode film layer, the contact area between the primer layer and the positive electrode film layer is increased, which helps to increase the area of electron transmission between the current collector and the positive electrode film layer, thereby reducing the internal resistance of the electrode plate and improving the kinetic performance of the battery.

In any embodiment, the battery cell includes a case, and the stacked type cell is accommodated in the case. The dimension of the case in a length direction is L₁, the dimension of the case in a width direction is W₁, and the dimension of the case in a thickness direction is H₁, wherein 450 mm≤L₁≤1300 mm, 100 mm≤W₁≤150 mm, and 14 mm≤H₁≤22 mm.

In any embodiment, the dimension of the case in the length direction is L₁, and 450 mm≤L₁≤650 mm.

When the dimension L₁ of the case in the length direction satisfies 450 mm≤L₁≤650 mm, the length of the battery cell is short, which helps to shorten the diffusion path of the current and reduce the internal resistance of the electrode plate, thereby reducing the heat generation of the battery and improving its kinetic performance; in addition, the short length of the case helps to shorten the diffusion path of the electrolyte solution during the infiltration process, improving the infiltration rate and uniformity of the electrolyte solution, further promoting the uniformity of deintercalation of lithium ions during cycling, alleviating the stress concentration phenomenon, reducing the risk of film layer peeling-off, and improving the cycle stability of the battery cell.

In any embodiment, the dimension of the case in the length direction is L₁, and 900 mm≤L₁≤1300 mm.

When the dimension L₁ of the case in the length direction satisfies 900 mm≤L₁≤1300 mm, the dimension of the battery cell is long, which helps to reduce the volume proportion of the case in the battery cell and increase the loading proportion of active materials. At the same time, the long battery cell can reduce the number of batteries required in the battery module, simplify the structural design of the battery module, and reduce the number and complexity of structural parts in the module, thereby improving the space utilization of the battery pack, and further helping to improve the volumetric energy density of the battery cell.

In any embodiment, the material of the case is a pouch material, and the pouch material includes an aluminum-plastic composite film.

In any embodiment, the material of the case includes a composite film formed by one or more of polypropylene (PP), polybutylene terephthalate (PBT), polybutylene succinate (PBS), nylon, polyethylene terephthalate (PET), and polyethylene (PE) and aluminum.

The pouch material has a high elongation rate, so the case is lighter, thinner and softer, which helps to improve the space utilization of the battery cell and thus increase the energy density of the battery cell. In addition, the high barrier property of aluminum can effectively reduce the penetration of water and oxygen into the battery, reduce the decomposition of the electrolyte solution and the oxidation degree of the electrode material, thereby increasing the battery life.

In any embodiment, the capacity of the battery cell at 25 °C is 95 Ah to 300 Ah.

In any embodiment, the capacity of the battery cell at 25 °C is 150 Ah to 190 Ah.

A second aspect of the present application provides a battery apparatus, including the battery cell according to the first aspect of the present application.

A third aspect of the present application provides an electrical apparatus which includes the battery apparatus provided in the second aspect, where the battery apparatus is configured to provide electric energy.

A fourth aspect of the present application provides an energy storage apparatus which includes the battery apparatus provided in the second aspect, where the battery apparatus is configured to store electric energy.

### BRIEF DESCRIPTION OF DRAWINGS

FIG. 1 is a schematic diagram of a separator according to an embodiment of the present application;

FIG. 2 is a schematic diagram of a separator in the prior art;

FIG. 3 is a schematic diagram of the surface topography of an adhesive layer according to an embodiment of the present application;

FIG. 4 is a schematic diagram of a pouch stacked type battery according to the present application;

FIG. 5 is a schematic diagram of an electrical apparatus according to an embodiment of the present application.

### DESCRIPTION OF REFERENCE NUMERALS

5 battery cell; 50 case; 20 separator; 201 base film; 202 ceramic layer; 203 adhesive layer; X length direction; Y width direction; Z thickness direction.

### DETAILED DESCRIPTION

Embodiments of a battery cell, a battery apparatus, an electrical apparatus and an energy storage apparatus of the present application are specifically disclosed below with appropriate reference to the detailed description of the accompanying drawings. However, there are cases where unnecessary detailed descriptions are omitted. For example, there are cases where detailed descriptions of well-known items and repeated descriptions of actually identical structures are omitted. This is to avoid unnecessary redundancy in the following descriptions and to facilitate understanding by those skilled in the art. In addition, the accompanying drawings and subsequent descriptions are provided for those skilled in the art to fully understand the present application, and are not intended to limit the subject matter recited in the claims.

The “ranges” disclosed in the present application are defined in the form of lower and upper limits. A given range is defined by selecting a lower limit and an upper limit, and the selected lower and upper limits define the boundaries of the particular range. The range defined in this way may include or may not include end values, and may be arbitrarily combined, that is, any lower limit can be combined with any upper limit to form a range. For example, if the ranges 60-120 and 80-110 are listed for specific parameters, it is understood that the ranges 60-110 and 80-120 are also expected. In addition, if the listed minimum range values are 1 and 2 and if the listed maximum range values are 3, 4, and 5, the following ranges can all be expected: 1-3, 1-4, 1-5, 2-3, 2-4, and 2-5. In the present application, unless otherwise specified, the numerical range “a-b” represents an abbreviated representation of any combination of real numbers between a and b, wherein a and b are both real numbers. For example, the numerical range “0-5” indicates that all real numbers between “0-5” have been listed herein, and “0-5” is only a shortened representation of these numerical combinations. In addition, when a parameter is expressed as an integer greater than or equal to 2, it is equivalent to disclosing that the parameter is, for example, an integer of 2, 3, 4, 5, 6, 7, 8, 9, 10, 11, 12, and the like.

Unless otherwise specifically stated, all embodiments and optional embodiments of the present application may be combined with each other to form new technical solutions, and such technical solutions should be considered as being included in the disclosure of the present application.

Unless otherwise specifically stated, all technical features and optional technical features of the present application may be combined with each other to form new technical solutions, and such technical solutions should be considered as being included in the disclosure of the present application.

Unless otherwise specified, all steps of the present application may be performed sequentially or randomly, and preferably sequentially. For example, the method includes steps (a) and (b), meaning that the method may include steps (a) and (b) performed sequentially, or may include steps (b) and (a) performed sequentially. For example, it is mentioned that the method may further include step (c), which means that step (c) may be added to the method in any order. For example, the method may include steps (a), (b) and (c), or may further include steps (a), (c) and (b), or may further include steps (c), (a) and (b), and the like.

In the present application, the terms “a plurality of” and “multiple” refer to two or more.

Unless otherwise stated, the terms used in the present application have the well-known meanings commonly understood by those skilled in the art.

Unless otherwise stated, numerical values of parameters mentioned in the present application may be measured using various testing methods commonly used in the art. For example, the numerical values may be measured according to testing methods given in the embodiments of the present application. Unless otherwise stated, all parameters are tested at 25 °C.

The battery apparatus in the embodiments of the present application may include one or more battery cell assemblies for providing voltage and capacity. The battery cell assembly may include a plurality of pouch battery cells, and the plurality of pouch battery cells are connected by series connection, or parallel connection, or parallel-series connection through a bus component. For example, the battery cell assembly is generally formed by arranging the plurality of pouch battery cells; and the battery cell assembly may be a battery module, which is an independent module formed by arranging and fixing the plurality of pouch battery cells. As an example, the battery module may be formed by bundling the plurality of battery cells with cable ties.

The battery apparatus may be a battery pack. The battery pack includes a box body and one or more battery cell assemblies. The battery cell assembly is accommodated in the box body. The battery cell assembly may be a battery module, which may be accommodated in a box body by fixing the battery module in the box body; or the battery cell assembly may also be accommodated in a box body by directly fixing a plurality of pouch battery cells in the box body.

In the embodiments of the present application, the box body may include a first box body and a second box body. The first box body and the second box body are fastened together to form an enclosure space inside the box body to accommodate the battery cell assembly. Enclosure here means covering or closing, and may be sealed or unsealed. The first box body may be a top cover or a bottom plate. As an example, the box body may include a top cover, a frame, and a bottom plate. The top cover and the bottom plate are respectively connected to the frame, so that an enclosure space is formed inside the box body to accommodate the battery cell assembly.

In the embodiments of the present application, the box body may be a part of a chassis structure of a vehicle. For example, a part of the box body may become at least a part of a vehicle floor, or a part of the box body may become at least a part of a cross beam and a longitudinal beam of a vehicle.

In the embodiments of the present application, the battery cell may be a secondary battery. The secondary battery refers to a battery cell that, after discharged, can be continuously used by charging to activate the active material; and the battery cell can be a lithium ion battery. The battery cell may have a flat structure.

The battery mentioned in the embodiments of the present application may be a single physical module including one or more battery cells to provide a higher voltage and capacity. For example, the battery mentioned in the present application may include a battery cell, a battery module, a battery pack, or the like.

The battery cell is a smallest unit that makes up the battery, and capable of achieving the charging and discharging functions separately.

When a plurality of battery cells are provided, the plurality of battery cells are connected in series, in parallel, or in series and parallel through busbar components. In some embodiments, the battery may be a battery module. When there are a plurality of battery cells, the plurality of battery cells are arranged and fixed to form a battery module. In some embodiments, the battery may be a battery pack. The battery pack includes a box body and a battery cell. The battery cell or the battery module is accommodated in the box body. In some embodiments, the box body may be a part of a chassis structure of a vehicle. For example, a part of the box body may become at least a part of a floor of the vehicle, or a part of the box body may become at least a part of a cross beam and a longitudinal beam of the vehicle.

In some embodiments, the battery may be an energy storage apparatus. The energy storage device includes an energy storage container, an energy storage cabinet, or the like.

In some embodiments, battery cells can be assembled into a battery module, the number of battery cells included in the battery module can be multiple, and the specific number can be adjusted according to the application and capacity of the battery module.

In some embodiments, the aforementioned battery module can further be assembled into a battery pack, and the number of battery modules included in the battery pack can be adjusted according to the application and capacity of the battery pack.

The battery cell includes an electrode assembly and an electrolyte.

The electrode assembly usually includes a positive electrode plate and a negative electrode plate. The negative electrode plate is the electrode that absorbs or lithiates lithium ions during charging and releases or delithiates lithium during discharging. The positive electrode plate is the electrode that releases or delithiates lithium ions during charging and absorbs or lithiates lithium during discharging.

Although lithium-containing transition metal phosphates have significant advantages in cycle stability when used as positive electrode active materials, their intrinsic gram capacity is significantly lower than that of ternary materials. The applicant has found that the use of a thick coating process in the electrode preparation process has become an effective technical means to compensate for the disadvantage of low capacity of lithium-containing phosphates. However, this process improvement also brings new technical challenges: thick electrodes will produce greater volume expansion during long-term cycling, resulting in increased internal stress, which makes it easy for the film layer to partially or even completely peel off from the electrode plate under the action of stress. On the one hand, the peel-off of the film layer brings about the loss of positive electrode active materials participating in the charge and discharge reaction. On the other hand, it forms an “island” effect, that is, isolated areas are formed between some active material particles or between the particles and the conductive agent, which cannot form good electrical contact and thus cannot participate in the charge and discharge reaction of the battery, causing capacity diving of the battery. At the same time, this part of material affects ion transmission, increases the internal resistance of the battery, causes local overheating of the battery, and increases the risk of thermal runaway, seriously affecting the service life of the battery. Therefore, how to improve energy density while keeping the battery capacity stable during cycling is still a technical problem that needs to be solved urgently.

According to a first aspect of the present application, a battery cell is provided. The battery cell includes a stacked type cell, the stacked type cell includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with at least part of the surface provided with a carbon material; when the battery cell is fully discharged, a compacted density of the positive electrode plate is 2.3 g/cm³ to 2.6 g/cm³; a single-side surface density of the positive electrode film layer is 0.25 g/1540.25 mm² to 0.45 g/1540.25 mm²; in a cross-section of the positive electrode film layer along a thickness direction of the positive electrode plate, in a cumulative distribution curve of sphericity area of particles with a particle size R1 satisfying R1≥1000 nm, L_{R1A50} is 0.6-0.8; and in a cumulative distribution curve of graphitization degree C value of the positive electrode film layer obtained in a surface scanning mode of a laser microscopic confocal Raman spectrometer, the median C₅₀ of the graphitization degree is 0.95-1.20; wherein the graphitization degree C value is I_{G}/I_{D}, I_{G} represents the intensity of G-band of the Raman spectrum at 1580±100 cm⁻¹, and I_{D} represents the intensity of D-band of the Raman spectrum at 1350±100 cm⁻¹.

Studies have shown that the stress concentration area of the film layer is prone to cracking under the action of cyclic expansion, becoming the starting point for film layer peeling-off, which is more significant in thick-coated battery cells. Compared with ternary materials, lithium-containing transition metal phosphates have a more stable structure and are less likely to break under high pressure. During the electrode plate compaction process, lithium-containing transition metal phosphates need to withstand higher pressures so as to increase the compacted density. However, when the battery cell is fully discharged, the compacted density of the positive electrode plate being greater than 2.6 g/cm³ will cause the electrode plate to be over-pressed, aggravate stress concentration, and increase the risk of film layer peeling-off during cycling; while the compacted density of the positive electrode plate being less than 2.3 g/cm³ will make the contact degree of the positive electrode film layer particles insufficient, resulting in increased internal resistance of the battery and affecting the energy density of the battery cell; the single-side surface density of the positive electrode film layer being lower than 0.25 g/1540.25 mm² cannot meet the requirements of high energy density; and the single-side surface density of the positive electrode film layer being higher than 0.45 g/1540.25 mm² will make the positive electrode film layer too thick, then the volume expansion during cycling is significant, stress concentration is aggravated, and the risk of film layer peeling-off is increased.

Stacked type cells are beneficial to improving the space utilization of batteries, thereby further increasing the volumetric energy density of battery cells and increasing battery capacity. The applicant has found that in thick-coated stacked type cells, stress concentration usually originates from local stress generated during the compaction process. On the one hand, during the compaction process, the force-bearing surface of particles with low sphericity is sharp and it is not easy for particles to slip during the compaction process. Under the action of stress, the mutual obstruction between particles can easily lead to stress concentration. In the cross-section of the positive electrode film layer along the thickness direction of the positive electrode plate, in the cumulative distribution curve of sphericity area of particles with a particle size R1 satisfying R1≥1000 nm, when the L_{R1A50} is less than 0.6, a large local stress will be generated in the particles during the compaction process, and the risk of film layer peeling-off during cycling will increase significantly; on the other hand, the median C₅₀ of the graphitization degree reflects the degree of order in the carbon material layer. When C₅₀ is less than 0.95, the slippage of the carbon layer structure is reduced, resulting in large friction between particles during compaction and making slippage difficult, further increasing the stress during the compaction process, thereby increasing the probability of film layer peeling-off during cycling. Lithium-containing transition metal phosphate particles often require high-temperature sintering. As the sintering temperature or time increases, the grain boundaries of the particles melt, the particles grow, and the graphitization degree increases, but the sphericity of the particles decreases. In order to take into account the sphericity and graphitization degree of the particles in the film layer and reduce the cask effect of stress concentration caused by either one during the compaction process, the median sphericity of particles with a particle size R1 satisfying R1≥1000 nm is often not exceed 0.8; and the median C₅₀ of the graphitization degree of the positive electrode film layer is usually not higher than 1.2.

The battery cell provided in the present application adopts a process involving thick coating and stacked type cell, and controls the compacted density of the positive electrode plate to be 2.3 g/cm³ to 2.6 g/cm³ when the battery cell is fully discharged; the single-side surface density of the positive electrode film layer is 0.25 g/1540.25 mm² to 0.45 g/1540.25 mm², thereby alleviating stress concentration, reducing the probability of film layer peeling-off, and improving the cycle life of the battery while improving the battery capacity; further, by controlling the L_{R1A50} in the cumulative distribution curve of sphericity area of particles with a particle size R1 satisfying R1≥1000 nm in the cross-section of the positive electrode film layer along the thickness direction of the electrode plate to be 0.6-0.8, and controlling the median value C₅₀ of the graphitization degree in the cumulative distribution curve of graphitization degree C value of the positive electrode film layer obtained in the surface scanning mode of the laser microscopic confocal Raman spectrometer to be 0.95-1.20, the sphericity of large particles in the positive electrode film layer and the graphitization degree of the positive electrode film layer are improved, thereby improving the local stress generated during the compaction process, further reducing the probability of film layer peeling-off and improving the cycle life of the battery.

In summary, the battery cell of the present application has high capacity while improving its capacity diving problem, and taking into account the cycle life of the battery.

In the present application, a stacked type cell refers to a battery cell formed by stacking a positive electrode plate, a separator and a negative electrode plate.

In the present application, the positive electrode film layer contains lithium-containing transition metal phosphate, but the positive electrode film layer does not simply refer to the positive electrode active material layer. Other film layers that are connected to the positive electrode active material layer and are difficult to distinguish, such as the primer layer and liquid retention layer, are collectively referred to as the positive electrode film layer.

In the present application, lithium-containing transition metal phosphate refers to a phosphate material containing lithium element and transition metal element, which can be detected by any method known in the art. For example, it can be detected by combining X-ray diffractometer (XRD) with energy spectrum analyzer and inductively coupled plasma mass spectrometer.

In the present application, the carbon material disposed on at least part of the surface of the lithium-containing transition metal phosphate particles can be detected by any method known in the art. As an example, by characterizing the lithium-containing transition metal phosphate particles using a transmission electron microscope and an energy spectrum analyzer, it is possible to observe the carbon material disposed on at least part of the surface of the lithium-containing transition metal phosphate particles.

In the present application, the fully discharged state refers to a state in which the battery is placed in an oven environment at 25 °C, allowed to stand for 2 hours, when the battery temperature is maintained at 25 °C, the battery is discharged to 2.5 V at a constant current of 1/3 C, and then discharged to 2.0 V at a constant current of 0.1 C.

In the present application, the compacted density of the positive electrode plate may be tested by methods known in the art. As an example, the battery is placed in an oven environment at 25 °C and allowed to stand for 2 hours. When the battery temperature is maintained at 25 °C, the battery is discharged to 2.5V at a constant current of 1/3C and then discharged to 2.0V at a constant current of 0.1 C. The battery is disassembled to obtain the positive electrode plate. The residual electrolyte solution is treated with dimethyl carbonate solvent, the electrode plate is dried, and cut into small discs with an area of S. The mass is obtained as W₁, and the thickness T₁ of the positive electrode plate is measured using a micrometer. Then, the positive electrode film layer of the weighed electrode plate is wiped off, the mass of the current collector is weighed, recorded as W₂, and the thickness T₂ of the current collector is measured using a micrometer. The compacted density PD of the positive electrode plate=(W₁W₂)/[(T₁−T₂)×S].

In some embodiments, when the battery cell is fully discharged, the compacted density of the positive electrode plate can be selected to be 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.40 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.50 g/cm³, 2.52 g/cm³, 2.55 g/cm³, 2.60 g/cm³ or a numerical range between any two of these values.

In the present application, the single-side coating surface density of the positive electrode film layer has a meaning well-known in the art, and can be tested by methods known in the art. For example, a single-sided coated and cold-pressed positive electrode plate is taken (if it is a double-sided coated positive electrode plate, the positive electrode film layer on one side can be wiped off first), punched into small discs with an area of S₁, weighed, and the weight is recorded as M₁. Then, the positive electrode film layer of the weighed positive electrode plate is wiped off, and the weight of the current collector is weighed and recorded as M₀. Single-side surface density of positive electrode film layer=(M₁−M₀)/S₁. In order to ensure the accuracy of the test result, multiple groups (for example, 10 groups) of samples to be tested can be tested, and the average value can be calculated as the test result. The higher the single-side coating surface density of the positive electrode film layer, the greater the loading amount per unit area, which helps to increase the volumetric energy density of the battery cell.

In some embodiments, the single-side coating surface density of the positive electrode film layer can be selected to be 0.25 g/1540 mm², 0.26 g/1540 mm², 0.27 g/1540 mm², 0.28 g/1540 mm², 0.29 g/1540 mm², 0.3 0 g/1540 mm², 0.31 g/1540 mm², 0.32 g/1540 mm², 0.33 g/1540 mm², 0.34 g/1540 mm², 0.35 g/1540 mm², 0.36 g/1540 mm², 0.37 g/1540 mm², 0.38 g/1540 mm², 0.39 g/1540 mm², 0.40 g/1540 mm², 0.41 g/1540 mm², 0.42 g/1540 mm², 0.43 g/1540 mm², 0.44 g/1540 mm², 0.45 g/1540 mm² or a numerical range between any two of these values.

In some embodiments, the single-side coating surface density of the positive electrode film layer is 0.3 g/1540.25 mm² to 0.45 g/1540.25 mm².

In some embodiments, the single-side coating surface density of the positive electrode film layer is 0.35 g/1540.25 mm² to 0.4 g/1540.25 mm².

The single-side coating surface density of the positive electrode film layer being further within the above range helps to further improve the capacity of the battery while taking into account the cycling performance.

In the present application, the term “particle” refers to particles with identifiable complete boundaries in the field of view of the positive electrode film layer at a certain magnification, such as 10,000 times. Defects and scratches may exist inside the particles, but complete boundaries sufficient to separate the particles cannot be identified inside the particles. The positive electrode film layer in the present application can be either a freshly prepared positive electrode film layer or a positive electrode film layer obtained by disassembling a battery.

In the present application, the method for identifying particles is as follows: the positive electrode film layer is cut along the thickness direction of the electrode plate by an argon ion beam (as an example, the equipment model: Leica EMTIC3XCP, working voltage: 6 kV, working time: 6 h), and after the cross-section is exposed, a scanning electron microscope (as an example, the equipment model: Hitachi SU8230, working voltage: 3 kV, beam current: high, probe model: U (LA100), working distance <5 mm) is used to observe the cross-section of the positive electrode film layer along the thickness direction of the electrode plate. Field emission scanning electron microscopy is used to collect images in secondary electron mode at non-edge positions in the cross-section of the positive electrode film layer (after observing the edge of the electrode plate under the scanning electron microscope, the field of view is adjusted to the center of the sample). Electron microscope images are taken at a magnification of 10 k times, and the particles in the electron microscope images are analyzed using ImageJ software (1.46r, win64 version). The specific method of using ImageJ software is as follows: load the scanning electron microscope image to be analyzed; use the Cellpose plug-in software to identify particles and perform manual correction on this basis; and use ImageJ to read and calculate statistical data. The specific method for identifying particles using the Cellpose plug-in software is as follows: set the segmentation diameter parameter (diameter in the Segmentation module) to 15 pixels, click “runcyto3” to perform particle identification; and manually mark the particles in the image that are not recognized by the software or are not fully recognized by the software or are identified with errors. The particles in the image that are not recognized by the software, not fully recognized by the software, or recognized with errors mainly include the following types: 1. The particles are too large or there are scratches on the particle surface, resulting in that the particles cannot be identified or fully identified; 2. During the argon ion beam cutting process, scratches will be generated on the particle surface, then during the recognition process, the software may mistakenly determine the scratches as particle boundaries, thereby causing recognition errors; 3. The particles are too small to be successfully recognized; 4. The particles are located at the edge of the electron microscope field of view, and the interior of the particles is penetrated by the edge, the morphology cannot be fully displayed, and the part is recognized instead of the whole, resulting in recognition errors. Manual calibration is performed on the above-mentioned particles that are not identified or are identified with errors. The specific process is as follows: delete large particles that are located at the peripheral edge of the scanning electron microscope and are not fully displayed; and determine whether there are gap scratches inside other particles that are not identified or are identified with errors. If there are no gap scratches inside the particles, they are determined to be a single particle and manually marked according to the manually observed particle boundaries; in response to the presence of gap scratches inside the particles, it is determined whether the gap scratches penetrate the particles. If not, they are determined to be a single particle and manually marked; in response to the gap scratches penetrating the particles, it is determined whether the gap scratches are linear or irregular; in response to the gap scratches being irregular, they are determined to be boundaries between particles and the particles are separated along the boundaries; in response to the gap scratches being linear, contrast comparison is performed; in response to the contrast comparison being not significant and there being no sense of cracks, they are determined to be scratches and the particles are identified as a single particle; in response to the contrast comparison being strong and there being a sense of cracks, they are determined to be boundaries between particles and the particles are identified as two particles. After manual marking, the information irrelevant to the particles in the automatic image processing process is deleted, thus completing the determination and identification of particles in the image.

In the present application, the test method for the sphericity of particles with a particle size R1 satisfying R1≥1000 nm in a cross-section of the positive electrode film layer along the thickness direction of the positive electrode plate is as follows: refer to the method described above in the present application to identify the particles in the cross-section of the positive electrode film layer, and use the “shape description” analysis function in ImageJ to analyze the morphology of the particles in the cross-section of the positive electrode film layer along the thickness direction of the electrode plate. According to the software manual (ImageJ User Guide IJ 1.46r), the “Round” parameter obtained by analysis represents the ratio of the pixel area of the particle to the area of the circle with the fitted major diameter as the diameter, which can be used to characterize the sphericity of the particle. The closer the particle is to a sphere, the closer the ratio of the pixel area to the area of the circle with the fitted major diameter as the diameter is to 1. Therefore, the “Round” parameter of the particles obtained by analysis is used to characterize the sphericity of the particles. The sphericities of at least 1000 particles with a particle size R1 satisfying R1≥1000 nm are arranged in ascending order, with the sphericity as the horizontal axis and the cumulative area proportion as the vertical axis, to obtain a cumulative distribution curve of the sphericity of particles with a particle size R1 satisfying R1≥1000 nm in the positive electrode film layer. L_{R1A1}50 is the sphericity L value when the cumulative area of the vertical axis accounts for 50% in the cumulative distribution curve of sphericity L value of particles with a particle sizeR1 satisfying R1≥1000 nm.

In some embodiments, in the cross-section of the positive electrode film layer along the thickness direction of the positive electrode plate, in the cumulative distribution curve of sphericity area of particles with a particle size R1 satisfying R1≥1000 nm, L_{R1A50} can be selected to be 0.60, 0.61, 0.62, 0.63, 0.64, 0.65, 0.66, 0.67, 0.68, 0.69, 0.70, 0.705, 0.71, 0.72, 0.73, 0.74, 0.75, 0.76, 0.77, 0.78, 0.79, 0.80 or a numerical range between any two of these values.

Those skilled in the art can adjust the sphericity of particles by any known process. As an example, the sphericity of the particles can be adjusted through processes such as grinding, polishing, chemical etching, mechanical stirring, compression, coating, granulation, and adding surfactants, and adjustment of the parameters of each process.

In the present application, the cumulative distribution curve of graphitization degree C value refers to a curve obtained by arranging the obtained at least 100 C values in ascending order, with graphitization degree as the horizontal axis and the proportion of cumulative quantity as the vertical axis. C₅₀ is the C value when the cumulative quantity of the vertical axis accounts for 50% in the cumulative distribution curve of graphitization degree C value. Compared with point values, the median C₅₀ of the graphitization degree can reflect the overall graphitization degree of the particles in the positive electrode film layer, that is, slippage; compared with the mean value, it can reduce the influence of extreme values during the test process and improve the confidence of the test results.

The graphitization degree C value of the positive electrode film layer can be obtained by a surface scanning mode of a laser microscopic confocal Raman spectrometer. As an example, specifically, a laser microscopic confocal Raman spectrometer (high-precision Renishaw laser microscopic confocal Raman spectrometer) is used, an excitation wavelength of 532 nm is selected, and an appropriate amount of positive electrode film layer is taken to perform a surface scan on its surface or cross-section along the thickness direction of the electrode plate. The scanning area is 45 μm×45 μm, divided into 10×10 grids, and the grid vertices are used as test points. The step size is 5 μm, and the total number of scanning points is 100, thereby obtaining the C values of different sites and the cumulative distribution curve of C value of the surface scan area. The positive electrode film layer in the present application can be either a freshly prepared positive electrode film layer or a positive electrode film layer obtained by disassembling a battery. The surface of the positive electrode film layer obtained from disassembly of the battery inevitably has residual electrolyte salt particles. In order to improve the test accuracy, it is preferred to perform a surface scan on the cross-section of the positive electrode film layer along the thickness direction of the electrode plate to characterize the graphitization degree of the positive electrode film layer.

The graphitization degree C value of the positive electrode film layer is obtained by a ratio of band intensities of the G-band and the D-band of the Raman spectrum. The G band position is 1580±100 cm⁻¹, which characterizes the carbon sp² hybrid structure; the D band position is 1350±100 cm⁻¹, which characterizes a disordered structure, where the disorder indicates that there is no regular arrangement between the carbon atoms in the structure. In graphite crystals, carbon atoms in the same layer form covalent bonds by sp² hybridization, and the van der Waals force between the layers makes the carbon in the graphite structure easy to slip. Therefore, the C value can characterize the graphitization degree of the positive electrode film layer. It can be understood that the graphitization degree in the positive electrode film layer mainly comes from the carbon material in the positive electrode film layer that has undergone graphitization treatment, that is, the carbon material layer of the positive electrode active material. Although carbon nanotube conductive agents rich in sp² hybrid structure also have relatively high I_{G}/I_{D}, due to their low addition content and small tube diameter, their addition to the positive electrode film layer shows an extreme value in the Raman surface scanning test of the positive electrode film layer, and will not affect the graphitization degree C₅₀ in the positive electrode film layer. Therefore, the graphitization degree of the positive electrode film layer can also be used to characterize the graphitization degree of the positive electrode active material.

Those skilled in the art can adjust the graphitization degree of active material particles by any known process. As an example, the graphitization degree of the active material particles can be adjusted by regulating the carbon source, sintering temperature, sintering time, sintering pressure, and sintering atmosphere.

The higher the graphitization degree of the carbon on the surface of the positive electrode active material, the higher the proportion of graphitized carbon in the positive electrode film layer, and the easier it is for the particles to slip with the help of the highly graphitized carbon structure in the coating layer, thereby reducing the stress concentration phenomenon in the electrode plate.

In some embodiments, in the cumulative distribution curve of graphitization degree C value of the positive electrode film layer obtained in a surface scanning mode of a laser microscopic confocal Raman spectrometer, the median C₅₀ of the graphitization degree can be selected to be 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20 or a numerical range between any two of these values.

In some embodiments, in the cumulative distribution curve of graphitization degree C value of the positive electrode film layer obtained in the surface scanning mode of the laser microscopic confocal Raman spectrometer, the median value C₅₀ of the graphitization degree is 1.01-1.13.

The graphitization degree of the positive electrode film layer being further within the above range helps to further improve the slippage of particles in the positive electrode film layer, reduce stress concentration in the positive electrode film layer, and thus further improve the long-cycle stability of the battery cell.

In some embodiments, in the cross-section of the positive electrode film layer along the thickness direction of the positive electrode plate, in the cumulative distribution curve of sphericity of particles with a particle size R1 satisfying R1≥1000 nm, L_{R1A50} is 0.65-0.75.

In some embodiments, in the cross-section of the positive electrode film layer along the thickness direction of the positive electrode plate, in the cumulative distribution curve of sphericity of particles with a particle size R1 satisfying R1≥1000 nm, L_{R1A50} is 0.67-0.72.

In the cross-section of the positive electrode film layer along the thickness direction of the positive electrode plate, in the cumulative distribution curve of sphericity area of particles with a particle size R1 satisfying R1≥1000 nm, L_{R1A50} is in the range of 0.65-0.75, and further in the range of 0.67-0.72, which is beneficial to further reducing the stress concentration at large particles in the positive electrode film layer of the thick-coated stacked type cell, thereby reducing the probability of film layer peeling-off and improving the cycle life of the battery.

In some embodiments, the single-side thickness H of the positive electrode film layer is 70 μm to 120 μm.

In some embodiments, the single-side thickness H of the positive electrode film layer is 90 μm to 120 μm.

The thickness of the positive electrode film layer can be detected by any method known in the art. As an example, the thickness of the positive electrode film layer in the cross-section of the positive electrode plate along the thickness direction is measured by a scanning electron microscope.

In some embodiments, the single-side thickness H of the positive electrode film layer can be selected to be 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, 100 μm, 101 μm, 102 μm, 103 μm, 104 μm, 105 μm, 106 μm, 107 μm, 108 μm, 109 μm, 110 μm, 111 μm, 112 μm, 113 μm, 114 μm, 115 μm, 116 μm, 117 μm, 118 μm, 119 μm, 120 μm or a numerical range between any two of these values.

The single-side thickness of the positive electrode film layer being within the above range helps to increase the loading amount of the positive electrode active material in the battery, thereby increasing the capacity of the battery.

In some embodiments, the single-side thickness H of the positive electrode film layer is 100 μm to 120 μm.

Increasing the thickness of the positive electrode film layer helps to increase the loading amount of the positive electrode active material and helps to increase the capacity of the battery. However, the applicant found that when the single-side thickness of the positive electrode film layer is greater than or equal to 100 μm, during cycling of the battery, the volume expansion of the positive electrode film layer is more significant, thereby generating greater stress, the stress concentration phenomenon in the positive electrode film layer is more significant, and the risk of film layer peeling-off increases, thereby affecting the cycling performance of the battery. The embodiments of the present application increase the capacity of the battery by increasing the thickness of the positive electrode film layer, and at the same time controls the sphericity of particles with a particle size R1 satisfying R1≥1000 nm in the cross-section of the positive electrode film layer along the thickness direction of the positive electrode plate, and the median value C₅₀ of the graphitization degree in the cumulative distribution curve of graphitization degree C value of the positive electrode film layer obtained in the surface scanning mode of the laser microscopic confocal Raman spectrometer to increase the slippage degree between particles in the positive electrode film layer and reduce the stress concentration generated during the compaction process of the electrode plate, thereby increasing the battery capacity while taking into account the cycling performance of the battery.

In some embodiments, based on the total area of particles in the cross-section of the positive electrode film layer along the thickness direction of the electrode plate, the area of particles with a particle size R1 satisfying R1≥1000 nm accounts for 12% to 50%.

It can be understood that the particles in the cross-section of the positive electrode film layer along the thickness direction of the electrode plate, especially the particles larger than 50 nm, mainly come from the positive electrode active material. Therefore, the embodiments of the present application can accurately and objectively reflect the distribution of lithium-containing transition metal phosphate particles in the positive electrode film layer by observing and counting the particle area in the cross-section of the positive electrode plate along the thickness direction of the electrode plate.

In the prior art, a laser particle size analyzer is generally used to statistically analyze the particle size of the positive electrode active material through the Malvern laser diffraction method. However, the applicant's research shows that since lithium-containing transition metal phosphate particles are prone to agglomeration, the test results obtained by the Malvern laser diffraction method based on the laser scattering principle often indicate the particle size of the particle agglomerates, and cannot truly reflect the particle size of the particles in the positive electrode active material, and even less can it reflect the dispersion state of the positive electrode active material in the film layer, because the dispersion degree of the positive electrode active material in the film layer will increase during the slurrying and film-forming and rolling process. The test results obtained by the Malvern laser diffraction method are affected by the particle size, specific surface area, and degree of agglomeration of the positive electrode active material. Compared with the actual dispersion in the electrode plate, the number of large particles obtained by the test is lower than the actual value, and the number of small particles is higher than the actual value. Therefore, the particle size obtained by the test based on Malvern laser diffraction method cannot be equivalent to or analogous to the particle size obtained by statistics in the embodiments of the present application.

The specific test method for the area proportion of particles with a particle size R1 satisfying R1≥1000 nm in the cross-section of the positive electrode film layer along the thickness direction of the electrode plate is as follows: refer to the method described above in the present application to identify the particles in the positive electrode film layer, import the pictures having particle identification and marking completed into ImageJ software for analysis, complete the scale setting according to the scanning electron microscope image, and use the “Feret diameter”, “Area”, “Round” and “Solidity” analysis functions to perform statistical analysis on the particle size, area, sphericity and roughness of the particles in the cross-section of the positive electrode film layer along the thickness direction of the electrode plate. According to the software manual (ImageJUserGuideIJ 1.46r), the “Feret” parameter obtained by analysis represents the maximum distance between all parallel lines in the two-dimensional projection of the particle, which characterizes the particle size of the particle; and the “Area” parameter obtained represents the pixel area of the particle. Particles with a particle size smaller than 50 nm have large errors in the statistical process and are difficult to identify accurately, and the particle size of the conductive agent is generally smaller than 50 nm, which will cause large errors in the statistical results. Therefore, particles with a particle size smaller than 50 nm will not be statistically analyzed in the particle size statistics process of the present application, and the particle statistical data when AR, Round or Solidity is displayed as “NaN” will be deleted. The sum of the “Area” parameters of particles with a particle size R1 satisfying R1≥1000 nm and the sum of the “Area” parameters of all particles are calculated as the area of particles with a particle size R1 satisfying R1≥1000 nm and the statistical total area of the particles, respectively. The sum of the areas of the particles with a particle size R1 satisfying R1≥1000 nm divided by the statistical total area of the particles is taken as the area proportion of particles with a particle size R1 satisfying R1≥1000 nm in the cross-section of the positive electrode film layer along the thickness direction of the electrode plate.

In some embodiments, based on the total area of the particles in the cross-section of the positive electrode film layer along the thickness direction of the electrode plate, the area proportion of the particles with a particle size R1 satisfying R1≥1000 nm can be selected to be 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50% or a numerical range between any two of these values.

In some embodiments, based on the total area of particles in the cross-section of the positive electrode film layer along the thickness direction of the electrode plate, the area of particles with a particle size R1 satisfying R1≥1000 nm accounts for 12% to 40%.

Large particles with a particle size R1 satisfying R1≥1000 nm help to increase the compacted density of the positive electrode plate, thereby increasing the volumetric energy density of the battery cell; however, researchers have found that these large particles are prone to inducing stress concentration, increasing the risk of peeling-off of the positive electrode film layer. Therefore, the area proportion of particles with a particle size R1 satisfying R1≥1000 nm in the cross-section of the positive electrode film layer along the thickness direction of the electrode plate being in the range of 12% to 50%, further in the range of 12%-40% not only can improve the compacted density of the electrode plate, but also can prevent the probability of film layer peeling-off from being too high, thereby improving the energy density of thick-coated lithium-containing transition metal phosphate batteries while alleviating the capacity diving problem and taking into account the cycle life of the battery.

In some embodiments, the distribution uniformity of particles with a particle size R1 satisfying R1≥1000 nm in the cross-section of the positive electrode film layer along the thickness direction of the electrode plate is less than or equal to 5%.

The distribution uniformity of particles with a particle size R1 satisfyingR1≥1000 nm in a cross-section of the positive electrode film layer along the thickness direction of the electrode plate can be tested using methods known in the art. As an example, the cross-section of the positive electrode film layer along the thickness direction of the electrode plate is divided into three layers of equal thickness along the thickness direction of the electrode plate (when the surface of the positive electrode current collector is coated with a primer layer and then coated with a positive electrode active material layer, in the cross-section of the positive electrode film layer along the thickness direction of the electrode plate, the area from the position where the positive electrode film layer is 5 μm from the positive electrode current collector to the surface of the positive electrode film layer away from the positive electrode current collector is divided into three layers of equal thickness along the thickness direction of the electrode plate), which are respectively the lower layer close to the positive electrode current collector, the upper layer away from the positive electrode current collector, and the middle layer placed between the upper and lower layers; 10 non-overlapping fields of view are randomly selected in each of the upper, middle and lower layers, and scanning electron microscope images are taken at a magnification of 10 k; the 10 scanning electron microscope images taken from each layer were imported into ImageJ software for analysis, and according to the above-mentioned “test method for the area proportion of particles with a particle size R1 satisfying R1≥1000 nm in the cross-section of the positive electrode film layer along the thickness direction of the electrode plate”, the area proportion of particles with a particle size R1 satisfying R1≥1000 nm in the 10 images corresponding to each of the upper, middle and lower layers are obtained, with a total of 3 values. The range of the three values of the upper, middle and lower layers is the distribution uniformity of particles with a particle size R1 satisfying R1≥1000 nm in the cross-section of the positive electrode film layer along the thickness direction of the electrode plate, where the range is the difference between the maximum and minimum values of the three values of the upper, middle and lower layers. The smaller the distribution uniformity of particles with a particle size R1 satisfying R1≥1000 nm in the cross-section of the positive electrode film layer along the thickness direction of the electrode plate, the more uniform the distribution of large particles with a particle size R1 satisfying R1≥1000 nm in the positive electrode film layer, which helps to reduce the stress concentration phenomenon at large particles in the positive electrode film layer, reduce the probability of film layer peeling, and improve the cycle performance of the battery.

In some embodiments, the distribution uniformity of the particles with a particle size R1 satisfying R1≥1000 nm in the cross-section of the positive electrode film layer along the thickness direction of the electrode plate can be selected to be 0.01%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5% or a numerical range between any two of these values.

In some embodiments, the distribution uniformity of particles with a particle size R1 satisfying R1≥1000 nm in the cross-section of the positive electrode film layer along the thickness direction of the electrode plate is 0.2% to 2.5%.

In some embodiments, the distribution uniformity of particles with a particle size R1 satisfying R1≥1000 nm in the cross-section of the positive electrode film layer along the thickness direction of the electrode plate is 0.2% to 2%.

The distribution uniformity of particles with a particle size R1 satisfyingR1≥1000 nm in the cross-section of the positive electrode film layer along the thickness direction of the electrode being within the above range can effectively reduce the stress concentration in local regions of the film layer, so that the stress in the compaction process of the film layer can be evenly distributed in the whole area of the film layer, thereby increasing the energy density of the battery while reducing the probability of film layer peeling-off, alleviating the capacity diving problem of thick-coated lithium-containing transition metal phosphate batteries, and improving the cycle life of the battery.

In some embodiments, in a cumulative distribution curve of coating value B of the positive electrode film layer obtained in the surface scanning mode of the laser microscopic confocal Raman spectrometer, the median B₅₀ of the coating value is 0.30-0.60, wherein the coating value B is I_{P}/I_{D}, I_{P} represents the intensity of P-band of the Raman spectrum at 948±100 cm⁻¹, and I_{P} represents the intensity of D-band of the Raman spectrum at 1350±100 cm⁻¹.

The cumulative distribution curve of coating value B refers to a curve obtained by arranging the obtained at least 100 B values in ascending order, with coating value as the horizontal axis and the proportion of cumulative quantity as the vertical axis. In order to reduce the influence of the extreme coating value caused by the non-particle area in the positive electrode film layer on the test results, the median of the coating value B₅₀ is used to evaluate the density of the carbon material layer on the positive electrode active material. B₅₀ is the B value when the cumulative quantity of the vertical axis accounts for 50% in the cumulative distribution curve of coating value B.

In the present application, the coating value B of the positive electrode film layer can be obtained by scanning with a laser microscopic confocal Raman spectrometer. As an example, specifically, a laser microscopic confocal Raman spectrometer (high-precision Renishaw laser microscopic confocal Raman spectrometer) is used, an excitation wavelength of 532 nm is selected, and an appropriate amount of positive electrode film layer is taken to perform a surface scan on its surface or cross-section along the thickness direction of the electrode plate. The scanning area is 45 μm×45 μm, divided into 10×10 grids, and the grid vertices are used as test points. The step size is 5 μm, and the total number of scanning points is 100, thereby obtaining the B values of different sites and the cumulative distribution curve of B value of the surface scan area. The positive electrode film layer in the present application can be either a freshly prepared positive electrode film layer or a positive electrode film layer obtained by disassembling a battery. The surface of the positive electrode film layer obtained from disassembly of the battery inevitably has residual electrolyte salt particles. In order to improve the test accuracy, it is preferred to perform a surface scan on the cross-section of the positive electrode film layer along the thickness direction of the electrode plate to characterize the coating value of the positive electrode film layer.

The coating value B of the positive electrode film layer is obtained by a ratio of band intensities of the P-band and the D-band of the Raman spectrum. The P band position is 948±100 cm⁻¹, which characterizes the structure of phosphate PO₄³⁻; the D band position is 1350±100 cm⁻¹, which characterizes a disordered structure, where the disorder indicates that there is no regular arrangement between the carbon atoms in the structure. During the test, an excitation wavelength of 532 nm is selected, and the test depth is shallow. Therefore, in the test results of the positive electrode film layer obtained in the surface scanning mode of the laser microscopic confocal Raman spectrometer, the carbon structure peak shows a higher intensity than the phosphate structure peak.

Those skilled in the art can adjust the coating value of active material particles by any known process. As an example, the coating value of the active material particles can be adjusted by regulating the carbon source type, amount of added carbon source, sintering temperature, sintering time, sintering pressure, and sintering atmosphere. The coating value B can reflect the density of the carbon material layer on the surface of the lithium-containing transition metal phosphate particles. The denser the carbon material layer, the lower the phosphate structure strength detected in the Raman spectrum, and the smaller the coating value B of the positive electrode film layer.

In some embodiments, the positive electrode film layer further includes a coating layer disposed on at least part of the surface of the lithium-containing transition metal phosphate particles. In the cumulative distribution curve of coating value B of the positive electrode film layer obtained by the surface scanning mode of the laser microscopic confocal Raman spectrometer, the median B₅₀ of the coating value can be selected to be 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6 or a numerical range between any two of these values.

The median B₅₀ of the coating value of the positive electrode film layer being within the above range indicates that the carbon material layer of the positive electrode active material is relatively dense and uniform, which is beneficial to improving the slippage uniformity of the positive electrode film layer during rolling and reducing the stress concentration phenomenon in the thick-coated positive electrode film layer; in addition, with the help of the dense and uniform carbon material layer, the large particles in the positive electrode film layer are easier to slip during the compaction process, thereby reducing the stress concentration phenomenon at the large particles in the thick-coated positive electrode film layer, reducing the probability of peeling-off of the positive electrode film layer, improving the battery capacity diving problem, and increasing the cycle life of the battery.

In some embodiments, the lithium-containing transition metal phosphate particle in the positive electrode film layer includes a component represented by the following general formula:

LiₘFeₓP_{y}OⱼQ_{q} Formula I,

wherein Q includes one or more of Al, Na, K, Mg, Cu, Mn, Cr, Zn, Pb, Ca, Co, Ni, Sr, Nb, V, Ti, B, S, Si, N, F, Cl and Br; 0.8≤m≤1.15, 0.9≤x≤1, 0.95≤y≤1, 3.5≤j≤4, and 0≤q≤0.1.

In some embodiments, m can be selected to be 0.8, 0.85, 0.9, 0.95, 0.98, 1.00, 1.03, 1.05, 1.08, 1.10, 1.13, 1.15 or a numerical range between any two of these values; x can be selected to be 0.9, 0.91, 0.92, 0.93, 0.94, 0.95, 0.96, 0.97, 0.98, 0.99, 1.0 or a numerical range between any two of these values; y can be selected to be 0.95, 0.96, 0.97, 0.98, 0.99, 1.00 or a numerical range between any two of these values; j can be selected to be 3.5, 3.6, 3.7, 3.8, 3.9, 4 or a numerical range between any two of these values; q can be selected to be 0, 0.01, 0.02, 0.03, 0.04, 0.05, 0.06, 0.07, 0.08, 0.09, 0.1 or a numerical range between any two of these values.

In some embodiments, the lithium-containing transition metal phosphate particle in the positive electrode film layer includes one or more of lithium iron phosphate, lithium manganese phosphate, lithium vanadium fluorophosphate, lithium iron manganese phosphate and modified materials thereof.

In some embodiments, the lithium-containing transition metal phosphate particle in the positive electrode film layer includes one or more of lithium iron phosphate, doping modified material thereof, and coating modified material thereof.

In some embodiments, the iron dissolution rate of the positive electrode material is 658 ppm to 1921 ppm.

The iron dissolution rate of the positive electrode material can be tested by a method known in the art. As an example, 7.5 g of positive electrode material powder obtained by scraping from the positive electrode film layer sample is weighed and added to 100.3 g of ascorbic acid solution with a mass concentration of 0.3% (the solvent is ultrapure water). After stirring at 500 revolutions per minute for 305 minutes, the solution is quickly aspirated using a 5 ml syringe, and the solution is filtered into a test tube using a 0.45 μm pore-size filter head. 1 mL of the supernatant is aspirated with a pipette, added to a glass volumetric flask and diluted 50 times. The solution is tested using an inductively coupled plasma mass spectrometer (ICP-OES) to obtain the iron element concentration in the solution. The iron dissolution rate of the positive electrode material is calculated using the formula: (ICP test iron element concentration x solution volume/mass of the solution involved in volume adjustment)×100.3 g/mass of the positive electrode material powder, the solution volume is 50 mL, and the mass of the solution involved in volume adjustment is 1 g.

In some embodiments, the iron dissolution rate of the positive electrode material can be 658 ppm, 700 ppm, 800 ppm, 890 μm, 900 ppm, 1000 ppm, 1058 μm, 1076 μm, 1100 ppm, 1143 μm, 1200 ppm, 1236 μm, 1300 ppm, 1311 μm, 1384 μm, 1349 μm, 1400 ppm, 1485 μm, 1500 ppm, 1531 μm, 1600 ppm, 1700 ppm, 1800 ppm, 1921 ppm or a numerical range between any two of these values.

In some embodiments, the iron dissolution rate of the positive electrode material is 658 ppm to 1485 ppm.

The iron element dissolved in the positive electrode material mainly comes from the positive electrode active material lithium-containing transition metal phosphate. The iron dissolution rate depends on the number of lattice defects of the lithium-containing transition metal phosphate on the one hand, and on the integrity and density of the carbon material layer on the surface of the positive electrode active material on the other hand. A lower iron dissolution rate indicates fewer lattice defects in the lithium-containing transition metal phosphate, which is beneficial to reducing the corrosion of the lattice in a weak acid environment; moreover, the more complete and dense the carbon material layer on the surface of the positive electrode active material is, the dissolution of iron ions in a weak acid environment is inhibited. The positive electrode material with an iron dissolution rate within the above range has relatively few lattice defects and a complete and dense carbon material layer, which is beneficial to improving the compressive resistance and slippage of particles in the positive electrode film layer under large rolling pressure, increasing the compacted density of the positive electrode film layer and reducing stress concentration in the positive electrode film layer, improving the energy density of the battery and taking into account the improvement of capacity diving problem of the battery.

In some embodiments, the mass content of titanium element is 500 ppm to 8000 ppm based on the total mass of the lithium-containing transition metal phosphate particles in the positive electrode film layer.

The types and contents of elements in the lithium-containing transition metal phosphate particles in the positive electrode film layer can be tested by any method known in the art. As an example, the titanium element and its content are tested using inductively coupled plasma optical emission spectrometry according to Appendix C of GB/T 33822-2017.

In some embodiments, based on the total mass of the lithium-containing transition metal phosphate particles in the positive electrode film layer, the mass content of the titanium element can be selected to be 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm or a numerical range between any two of these values.

In some embodiments, the mass content of titanium element is 1000 ppm to 3000 ppm based on the total mass of the lithium-containing transition metal phosphate particles in the positive electrode film layer.

The introduction of titanium element into the lithium-containing transition metal phosphate particles requires the addition of a titanium source during the preparation of the positive electrode active material. Titanium sources are often inert materials, which can reduce the reaction activity and particle size growth by adhering to the surface of the lithium-containing transition metal phosphate material. Increasing the graphitization degree of the positive electrode active material often requires a high sintering temperature or a long sintering time, but this will also increase the size of the particles in the positive electrode film layer, increase the stress concentration of the positive electrode film layer, and cause peeling-off of the positive electrode film layer. In the embodiments of the present application, a high content of titanium element is added to the lithium-containing transition metal phosphate particles, so that the reactivity of the raw materials for synthesizing the positive electrode active material is reduced, and the positive electrode active material can achieve the control over the proportion of large particles while having a high graphitization degree, thus reducing stress concentration in the positive electrode film layer, reducing the probability of peeling-off of the positive electrode film layer, and improving the energy density of the battery while taking into account the cycle life of the battery.

At the same time, the doping of titanium element in the positive electrode active material is beneficial to causing lattice distortion, reducing Li—O bond energy, increasing lithium ion transmission rate, and improving the kinetic performance of the battery. The lithium ion diffusion in the thick coating film layer is uneven, often accompanied by a significant lithium ion concentration gradient. The embodiments of the present application improve the solid-phase transmission rate of the positive electrode active material by adding a high content of titanium element to the lithium-containing transition metal phosphate particles, thereby improving the kinetic problems of thick electrode plate batteries.

In some embodiments, the mass content of vanadium element is 500 ppm to 5000 ppm based on the total mass of the lithium-containing transition metal phosphate particles in the positive electrode film layer.

The types and contents of elements in the lithium-containing transition metal phosphate particles in the positive electrode film layer can be tested by any method known in the art. As an example, the vanadium element and its content are tested using inductively coupled plasma optical emission spectrometry according to Appendix C of GB/T 33822-2017.

In some embodiments, based on the total mass of the lithium-containing transition metal phosphate particles in the positive electrode film layer, the mass content of the vanadium element can be selected to be 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm.

In some embodiments, the mass content of vanadium element is 500 ppm to 3000 ppm based on the total mass of the lithium-containing transition metal phosphate particles in the positive electrode film layer.

The vanadium element in the positive electrode film layer can be in multiple valence states. Among them, vanadium with a valence of +5 (V⁵⁺) can be doped at the phosphorus element site. Due to its large radius, it can cause lattice distortion and expand the diffusion channel of lithium ions, thereby improving the ionic conductivity of the positive electrode active material and improving the kinetic performance of the battery; vanadium with a valence of +3 (V³⁺) can be doped at the transition metal site to generate lithium holes through charge compensation, thereby improving the electronic conductivity of the positive electrode active material. In addition, the improved distribution uniformity of vanadium element in the lithium-containing transition metal phosphate particles helps to further improve the kinetic performance and reaction uniformity of the positive electrode film layer, thereby further improving the kinetic performance and cycling performance of the battery cell.

The mass content of vanadium element being within the above range helps to improve the kinetic performance of the positive electrode plate and the kinetic performance of the thick-coated lithium-containing transition metal phosphate battery. At the same time, the synergistic effect of titanium element, vanadium element and carbon nanotubes in the positive electrode film layer helps to form a good three-dimensional network, further improving the electronic conductivity and ionic conductivity of the positive electrode film layer, thereby further improving the kinetic performance of the thick-coated lithium-containing transition metal phosphate battery.

In some embodiments, the porosity of the negative electrode film layer is 14% to 28%.

In the present application, the porosity of the positive electrode film layer can be tested in the following manner: Import the scanning electron microscope images of the cross-section of the positive electrode film layer along the thickness direction of the electrode plate obtained as described above into ImageJ software, select a straight line tool, use a straight line to mark the scale length in the image, click “Analyze Set Scale”, and set scale parameters in the software according to the scale length in the image. Select a rectangle tool, select the image outside the scale area, use “Image Duplicate” to copy the selected area, and use “Image Type 8 bit” to adjust the image format; select “Analyze Set Measurements”, select the following five options: “Area”, “Mean gray value”, “Area Fraction”, “Limit to threshold”, “Feret's diameter”, select 3 for “Decimal places”, select “Image”, “Adjust”, and “Threshold” in sequence, set the values sequentially to 0 and 100 in the “Threshold” box, and then use the Analyze-Measure function to export the pore data in the electron microscope images of the cross-section. Use “Image”—“Overlay”—“Flatten” to export and obtain the pore image; click “Apply” in “Threshold”, then click “Analyze”—“Analyze Particles”, and select the four columns on the left to get the pore statistical data.

It can be understood that the “pore” in the cross-section of the positive electrode film layer is identified by using image color difference and threshold value in the embodiments of the present application. This “pore” is not the pore data obtained in the exhaust test, but is mainly used to characterize the gap between particles in the cross-section of the positive electrode film layer. This method is superior to the exhaust method because the porosity obtained by the exhaust method is related to the pores between particles and the pores in the carbon material layer on the surface of the particles, and cannot objectively reflect the pores between the particles.

In some embodiments, the porosity of the positive electrode film layer can be selected to be 14%, 15%, 16%, 17%, 18%, 19%, 20%, 21%, 22%, 23%, 24%, 25%, 26%, 27%, 28% or a numerical range between any two of these values.

The porosity of the positive electrode film layer being within the above range and the positive electrode film layer having good electrolyte solution infiltration rate and tortuosity is conducive to the diffusion of lithium ions in liquid and solid phases, helps to reduce the concentration polarization of the thick electrode plates, and improves the kinetic performance of the battery. At the same time, it helps to alleviate the volume expansion of the thick-coated electrode plates during cycling, reduce the mechanical stress of the film layer and reduce the stress concentration phenomenon, thereby reducing the risk of film layer peeling-off-off of the thick-coated electrode plates.

Especially in thick-coated pouch batteries, the gap between the case and the electrode plate is small, the volume occupancy of the film layer is large, the electrolyte solution holding volume is reduced, and the porosity of the positive electrode film layer is within the above range, which helps to improve the liquid retention rate of the battery cell and improve the kinetic performance of the battery.

In some embodiments, the positive electrode film layer further includes a conductive agent, and based on a total area of the cross-section of the positive electrode film layer along the thickness direction of the electrode plate, the area of an agglomeration region of the conductive agent accounts for 0.5% to 2.5%.

In the present application, based on the total area of the cross-section of the positive electrode film layer along the thickness direction of the electrode plate, the area proportion of the agglomeration region of the conductive agent can be tested by the following method. A similar method as described above is used to observe the cross-section of the positive electrode film layer along the thickness direction of the electrode layer through a scanning electron microscope, and the area of the agglomeration region of the conductive agent in the scanning electron microscope image is measured at a magnification of 3 k. Since the conductive agent is generally a carbon-based material, such as conductive carbon black, carbon nanotubes, etc., the aggregated conductive agent can be seen under the high magnification of a scanning electron microscope. The agglomeration region of the conductive agent often appears as black agglomerates compared with other areas in the positive electrode film layer. With the help of image analysis software, the agglomeration region of the conductive agent refers to the region in the scanning electron microscope image where the conductive agent is obviously aggregated and appears as a black region. Specifically, the scanning electron microscope image at a magnification of 3 k is imported into ImageJ, and the black agglomeration regions of the conductive agent with Feret greater than or equal to 2 μm are screened out. The sum of the areas of the screened regions is counted and recorded as the area of the agglomeration region of the conductive agent. The area proportion of the agglomeration region of the conductive agent is the ratio of the area of agglomeration region of the conductive agent to the total area of the imported scanning electron microscope images. Three scanning electron microscope images whose ranges do not overlap each other are randomly taken, and the average value of the area proportions of the agglomeration region of the conductive agent is determined as “the area proportion of the agglomeration region of the conductive agent based on the total area of the cross-section of the positive electrode film layer along the thickness direction of the electrode plate”.

In some embodiments, the positive electrode film layer further includes a conductive agent, and based on the total area of the cross-section of the positive electrode film layer along the thickness direction of the electrode plate, the area proportion of the agglomeration region of the conductive agent can be selected to be 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5% or a numerical range between any two of these values.

Based on the total area of the cross-section of the positive electrode film layer along the thickness direction of the electrode plate, the area proportion of the agglomeration region of the conductive agent being within the above range indicates that the conductive agent is evenly dispersed in the positive electrode film layer and is easy to form a uniform conductive network, which is particularly beneficial to reducing the problem of kinetic performance degradation caused by an increase in ion transmission path in the thick coating film layer, reducing the local polarization and even lithium plating problems generated in the battery during cycling, and improving the cycle life of the battery.

At the same time, studies have shown that large-sized first particles in the lithium-containing transition metal phosphate particles are prone to rebound. The agglomeration area of the conductive agent being within the above range can suppress the rebound of the lithium-containing transition metal phosphate particles with the help of the uniform distribution of the conductive agent, form mechanical constraints on the particles and even on the film layer, improve the cohesion of the film layer, reduce the phenomenon of powder falling-off and peeling-off of the film layer, and improve the cycle life of the battery.

In some embodiments, the positive electrode film layer further includes a conductive agent, and based on a total area of the cross-section of the positive electrode film layer along the thickness direction of the electrode plate, the area of an agglomeration region of the conductive agent accounts for 0.5% to 1.7%.

In the embodiments of the present application, the area proportion of the agglomeration region of the conductive agent being further within the above range indicates that the conductive agent is more evenly distributed in the positive electrode film layer, and the content of the conductive agent is relatively low. While improving the kinetic performance of the positive electrode film layer, it helps to reduce the space of the positive electrode active material occupied by excessive conductive agent, thereby further improving the volumetric energy density of the battery while improving the kinetic performance of the battery.

In some embodiments, the conductive agent includes carbon nanotubes, and the carbon nanotubes include one or more of single-walled carbon nanotubes, few-walled carbon nanotubes, and multi-walled carbon nanotubes.

In the present application, the term “carbon nanotube” refers to a nanomaterial having several to dozens of coaxial hollow tubes formed by rolling up graphene sheets formed by sp² hybrid bonding of carbon atoms. The diameter is usually in the range of several to dozens of nanometers, and the length can range from micrometers to centimeters, showing a high aspect ratio. According to the number of layers of graphene sheets, they can be divided into single-walled carbon nanotubes (SWCNTs), few-walled carbon nanotubes (FWCNTs) and multi-walled carbon nanotubes (MWCNTs). Carbon nanotubes have excellent conductivity and high elastic modulus.

Since carbon nanotubes have a one-dimensional structure, they can form a network structure in the positive electrode film layer. On the one hand, the high elastic modulus of carbon nanotubes enables its network structure not only to serve as a bridge for stress transmission, but also to constrain the thick-coated positive electrode film layer, inhibiting the rebound of the lithium-containing transition metal phosphate particles, effectively alleviating stress concentration, reducing the risk of film layer peeling-off, and thus improving the problem of battery capacity diving; on the other hand, the excellent conductivity of carbon nanotubes makes its network structure be an efficient electron transmission channel. Even if there is local film layer peeling-off, the thick electrode plate can still maintain high electron transmission efficiency in the in-plane direction and the thickness direction, thereby delaying the occurrence of the capacity diving problem and further improving the kinetic performance and cycle life of the battery.

In some embodiments, the conductive agent further includes conductive carbon black.

Conductive carbon black has a high specific surface area and thus has good liquid retention capacity. The thick electrode plate has a large expansion force during cycling, which makes the electrolyte solution easy to be squeezed out. The distribution of conductive carbon black in the positive electrode film layer is conducive to improving the liquid retention capacity of the thick electrode plate, further alleviating the phenomenon of battery capacity diving during cycling, and improving the cycle life of the battery.

In some embodiments, the agglomeration region of the conductive agent includes carbon nanotubes and conductive carbon black.

Researchers found that carbon nanotubes are prone to agglomeration due to their high surface energy, resulting in uneven dispersion in the positive electrode film layer and the inability to form an effective carbon nanotube network structure. The surface energies of conductive carbon black and carbon nanotubes are relatively close, allowing the carbon black to be adsorbed on the surface of carbon nanotubes and form a physical barrier, which increases the resistance to carbon nanotube agglomeration and reduces direct contact between carbon nanotubes, thereby inhibiting agglomeration and improving the distribution uniformity of carbon nanotubes in the positive electrode film layer. On the one hand, this helps to improve the conductivity of the thick-coated positive electrode film layer and improve the kinetic performance of the battery; on the other hand, it helps to enhance the constraining effect of carbon nanotubes on the positive electrode film layer, reduce the risk of peeling-off of the thick-coated positive electrode film layer, and further improve the kinetic performance and cycle life of the battery. In addition, the agglomeration of carbon nanotubes in the agglomeration region of the conductive agent will also lead to blockage of local ion transmission pathways in the agglomeration region of the conductive agent. The combination of conductive carbon black can improve the lithium ion transmission capacity of this region, reduce local polarization, and further improve the cycle stability of the battery.

In some embodiments, based on the mass of the positive electrode film layer, the mass content C₁ of the carbon nanotubes satisfies: 0<C1≤2.5%, and the mass content C₂ of the conductive carbon black satisfies: 0<C2≤2.5%.

In some embodiments, based on the mass of the positive electrode film layer, the mass content C₁ of the carbon nanotubes can be selected to be 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of these values.

In some embodiments, based on the mass of the positive electrode film layer, the mass content C₂ of the conductive carbon black can be selected to be 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5% or a numerical range between any two of these values.

The mass contents of carbon nanotubes and conductive carbon black being within the above ranges can effectively alleviate the agglomeration phenomenon of carbon nanotubes and form a good conductive network structure, thereby effectively reducing the stress concentration of the positive electrode film layer, and improving the liquid retention rate of the positive electrode plate during long cycles, further reducing the risk of peeling-off of the electrode plate film layer and the polarization degree, improving the kinetic performance of the battery while taking into account the capacity diving problem, and improving the cycle life of the battery.

In some embodiments, the positive electrode film layer further includes a dispersant, and the dispersant includes hydrogenated nitrile butadiene rubber (HNBR).

HNBR is obtained by hydrogenating nitrile butadiene rubber to saturate double bonds. Its highly saturated main chain structure makes it have excellent oil resistance, heat resistance and aging resistance. This allows it to remain stable in different environments and systems when used as a dispersant, and it is not easy to degrade or deteriorate, thereby effectively exerting its dispersing effect. HNBR molecular chain contains both polar nitrile groups and non-polar hydrocarbon segments. The polar nitrile group can interact with some polar substances or particle surfaces, such as being adsorbed on the surface of dispersed particles through hydrogen bonds, electrostatic effects, etc.; the non-polar hydrocarbon chain segments have good lipophilicity and can stretch and disperse well in a non-polar or weakly polar medium, so that the particles are evenly dispersed in the medium.

When HNBR is adsorbed on the surface of particles in a slurry, its long-chain molecules will form a physical barrier around the particles, preventing the particles from approaching and aggregating with each other, so that the particles remain relatively independent and dispersed in the system. At the same time, HNBR can reduce the surface tension between the dispersion medium and the dispersed particles, making the particles easier to be wetted by the medium, thereby promoting the dispersion of the particles in the medium. At the same time, it can also reduce the interfacial energy between particles and reduce the aggregation of particles driven by interfacial energy. Furthermore, when the slurry dries to form a film, the elastic network structure of HNBR can buffer the shrinkage stress caused by solvent volatilization, reduce the re-aggregation of the conductive agent due to capillary force in this process, reduce the area proportion of the agglomeration region of the conductive agent, and improve the kinetic performance and cycle life of the battery.

In some embodiments, based on the mass of the positive electrode film layer, the mass content of the dispersant is 0.5% to 2%.

In some embodiments, based on the mass of the positive electrode film layer, the mass content of the dispersant can be selected to be 0.5%, 0.6%, 0.7%, 0.8%, 0.9%, 1%, 1.5%, 2% or a numerical range between any two of these values.

The mass content of the dispersant being within the above range can achieve uniform dispersion of particles in the positive electrode film layer while maintaining a high loading amount of the positive electrode film layer, reduce stress concentration in the thick-coated lithium-containing transition metal phosphate positive electrode film layer, and effectively alleviate the capacity diving problem of the battery.

In some embodiments, the battery cell also includes a separator 20 arranged between the positive electrode plate and the negative electrode plate, the separator 20 includes a base film 201 as well as a ceramic layer 202 arranged on at least one side of the base film 201 and an adhesive layer 203 arranged on the side of at least one ceramic layer 202 away from the base film 201, the adhesive layer 203 is a continuous layer with a porous structure, and the adhesive layer 203 includes a vinylidene fluoride-based polymer.

In some embodiments, the battery cell also includes a separator arranged between the positive electrode plate and the negative electrode plate, and the separator includes a base film as well as ceramic layers arranged on both sides of the base film and adhesive layers arranged on the side of each of the ceramic layers away from the base film.

In some embodiments, the vinylidene fluoride-based polymer includes one or more of polyvinylidene fluoride (PVDF) and polyvinylidene fluoride-hexafluoropropylene copolymer (PVDF-HFP).

In some embodiments, the vinylidene fluoride-based polymer includes polyvinylidene fluoride (PVDF).

In the prior art, the adhesive layer of the separator usually uses water-based PVDF, which presents an island-like structure in the separator. As shown in FIG. 2, on the one hand, this is conducive to providing gaps for the expansion of the battery cell, and on the other hand, it is easy to manufacture; however, the contact area between the adhesive layer of such separator and the electrode plate is small, and the adhesive force is weak.

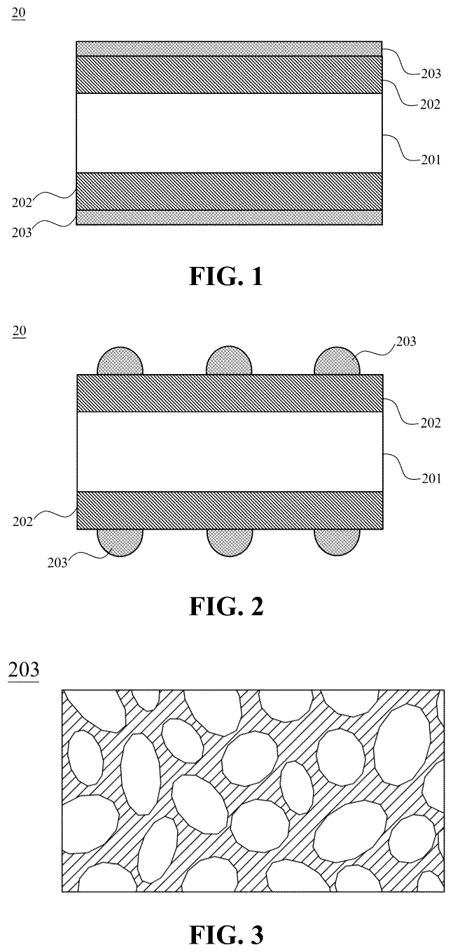

The separator provided in the embodiments of the present application uses a continuous layer with a porous structure as the adhesive layer, as shown in FIG. 1 and FIG. 3, its porous structure provides space for the expansion of the thick-coated battery cell, thereby improving the stability. At the same time, compared with the adhesive layer in the prior art, its adhesive area with the electrode plate is larger, thereby making the adhesion between the separator and the electrode plate more firm and uniform. Furthermore, when the positive electrode film layer rebounds, it is beneficial to maintaining the interface contact between the separator and the positive electrode film layer, thereby reducing the probability of film layer peeling-off.

It is understandable that the continuous adhesive layer may break and deform into a block structure due to contact or compression with the positive electrode plate or the negative electrode plate during the manufacturing or cycling of the electrode plate. The continuous structure referred to in the present application means that at the microscopic level, such as when observed under a scanning electron microscope or an optical microscope, the adhesive layer of the separator is continuous. In order to reflect the true morphology of the separator, during the sampling process, it is preferred to sample in the region of the separator in the battery where the adhesive layer is not adhered to the positive electrode plate or the negative electrode plate. As an example, sampling is performed at a position of the separator beyond the positive electrode plate and the negative electrode plate; or sampling is performed at a separator close to the surface of an electrode assembly. The adhesion between the separator sampling region and the positive electrode plate or the negative electrode plate is less, so the real state of the separator can be better reflected.

Compared with wound battery cells, the compression between the separator and the electrode plate in the stacked type cell is small, and the separator and the electrode plate are prone to relative displacement, which causes disturbance to the film layer, leading to powder falling-off or peeling-off of the film layer; in addition, it may also cause the positive and negative electrodes to overlap with each other, increasing the risk of internal short circuit in the battery cell. Therefore, the separator provided in the embodiments of the present application is particularly suitable for stacked type cells. The increased adhesive force between the porous adhesive layer and the electrode plate helps to improve the adhesive force between the separator and the electrode plate and reduce the relative displacement between the separator and the electrode plate. This helps to reduce the disturbance to the positive electrode film layer and the probability of film layer peeling-off, and also helps to reduce the risk of overlap between positive and negative electrodes which would cause short circuit of the battery cell.

In summary, when the vinylidene fluoride-based polymer in the adhesive layer of the embodiments of the present application is selected from the above materials, it helps to form a continuous and uniform porous adhesive layer. First, the adhesive force between the adhesive layer and the electrode plate is improved and evenly distributed, which helps to reduce the stress concentration phenomenon in the thick-coated lithium-containing transition metal phosphate positive electrode film layer and reduce the risk of film layer peeling-off, thereby helping to further improve the cycle life of the battery; secondly, the adhesive layer is stably adhered to the positive electrode plate or the negative electrode plate, which helps to reduce the direct contact between the positive electrode plate and the negative electrode plate due to the relative displacement between the electrode plate and the separator, reduces the risk of internal short circuit, and helps to improve the safety performance of the battery; thirdly, the porous adhesive layer helps to maintain the porosity of the separator, reserves space for the expansion of the battery cell, and further improves the cycle life of the battery.

In some embodiments, the material of the base film may include, but is not limited to, one or more of glass fiber, non-woven fabric, polyethylene (PE), and polypropylene (PP).

In some embodiments, the ceramic layer includes one or more of aluminum oxide (Al₂O₃), zirconium oxide (ZrO₂), titanium oxide (TiO₂), silicon oxide (SiO₂), and boron nitride (BN).

Ceramic particles are flame retardant and have a high hardness value. They are not easily deformed by heat and therefore have excellent dimensional stability. The low thermal conductivity of ceramic materials can further prevent certain thermal runaway points in the battery from expanding into overall thermal runaway, thereby improving the safety performance of the battery cell.

In some embodiments, the thickness of the base film in the separator is 7-9 μm.

In some embodiments, the thickness of the base film in the separator can be selected to be 7 μm, 7.5 μm, 8 μm, 8.5 μm, 9 μm, or a numerical range between any two of these values.

In some embodiments, the single-side thickness of the ceramic layer in the separator is 2-4 μm.

In some embodiments, the single-side thickness of the ceramic layer in the separator can be selected to be 2 μm, 2.5 μm, 3 μm, 3.5 μm, 4 μm or a numerical range between any two of these values.

In some embodiments, the single-side thickness of the adhesive layer in the separator is 1-5 μm.

In some embodiments, the single-side thickness of the adhesive layer in the separator can be selected to be 1 μm, 1.5 μm, 2 μm, 2.5 μm, 3 μm, 3.5 μm, 4 μm, 4.5 μm, 5 μm or a numerical range between any two of these values.

In the present application, the meaning of “thickness” is well known in the art, and it can be measured by methods and instruments known in the art. As an example, a high-precision micrometer (such as Mitutoyo 293-100, with an accuracy of 0.1 μm) can be used for testing.

If the thickness of the adhesive layer is too low, the void space in the separator will be small, and the adhesive force between the separator and the electrode plate will be low. On the one hand, the stress increases after the film layer expands, and the probability of film layer peeling-off increases, affecting the cycle life of the battery; on the other hand, the probability of short circuit due to the overlap between positive and negative electrode plates increases, thereby affecting the safety performance of the battery. If the thickness of the adhesive layer is too large, it will occupy a large space of the battery, thereby affecting the volumetric energy density of the battery. In the embodiments of the present application, the thickness of the adhesive layer being within the above range helps to take into account the cycle life, safety performance and volumetric energy density of the battery.

In some embodiments, the positive electrode film layer is provided with a primer layer at the bottom region close to the positive electrode current collector, the primer layer including a conductive agent and a binder, the conductive agent including carbon nanotubes and conductive carbon black, and the binder including polyvinylidene fluoride (PVDF).

In some embodiments, the thickness of the primer layer is 0.5 μm to 5 μm.

In some embodiments, the thickness of the primer layer can be selected to be 0.5 μm, 1 μm, 1.5 μm, 2 μm, 2.5 μm, 3 μm, 3.5 μm, 4 μm, 4.5 μm, 5 μm or a numerical range between any two of these values.

The primer layer provided in the embodiments of the present application helps to improve the adhesive force between the positive electrode film layer and the positive electrode current collector and alleviate the stress concentration phenomenon at large particles, thereby reducing the probability of peeling-off of the positive electrode film layer and improving the cycle stability of the battery. At the same time, compared with the direct contact between the positive electrode current collector and the positive electrode film layer, the contact area between the primer layer and the positive electrode film layer is increased, which helps to increase the area of electron transmission between the current collector and the positive electrode film layer, thereby reducing the internal resistance of the electrode plate and improving the kinetic performance of the battery.

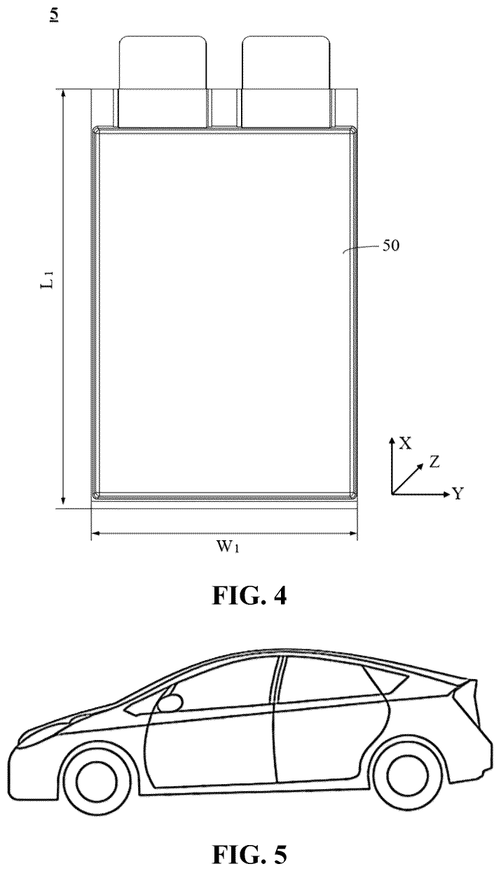

In some embodiments, as shown in FIG. 4, the battery cell 5 includes a case 50, and the stacked type cell is accommodated in the case 50. The dimension of the case 50 in a length direction X is L₁, the dimension of the case 50 in a width direction Y is W₁, and the dimension of the case 50 in a thickness direction Z is H₁, wherein 450 mm≤L₁≤1300 mm, 100 mm≤W₁≤150 mm, and 14 mm≤H₁≤22 mm.

In some embodiments, L₁ can be selected to be 450 mm, 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1000 mm, 1050 mm, 1100 mm, 1150 mm, 1200 mm, 1250 mm, 1300 mm or a numerical range between any two of these values.

In some embodiments, W₁ can be selected to be 100 mm, 110 mm, 120 mm, 130 mm, 140 mm, 150 mm or a numerical range between any two of these values.

In some embodiments, H₁ can be selected to be 14 mm, 15 mm, 16 mm, 17 mm, 18 mm, 19 mm, 20 mm, 21 mm, 22 mm or a numerical range between any two of these values.

In some embodiments, the dimension of the case in the length direction is L₁, and 450 mm≤L₁≤650 mm.

When the dimension L₁ of the case in the length direction satisfies 450 mm≤L₁≤650 mm, the length of the battery cell is short, which helps to shorten the diffusion path of the current and reduce the internal resistance of the electrode plate, thereby reducing the heat generation of the battery and improving its kinetic performance; in addition, the short length of the case helps to shorten the diffusion path of the electrolyte solution during the infiltration process, improving the infiltration rate and uniformity of the electrolyte solution, further promoting the uniformity of deintercalation of lithium ions during cycling, alleviating the stress concentration phenomenon, reducing the risk of film layer peeling-off, and improving the cycle stability of the battery cell.

In some embodiments, the dimension of the case in the length direction is L₁, and 900 mm≤L₁≤1300 mm.

When the dimension L₁ of the case in the length direction satisfies 900 mm≤L₁≤1300 mm, the dimension of the battery cell is long, which helps to reduce the volume proportion of the case in the battery cell and increase the loading proportion of active materials. At the same time, the long battery cell can reduce the number of batteries required in the battery module, simplify the structural design of the battery module, and reduce the number and complexity of structural parts in the module, thereby improving the space utilization of the battery pack, and further helping to improve the volumetric energy density of the battery cell.

In some embodiments, as shown in FIG. 4, the material of the case 50 is a pouch material, and the pouch material includes an aluminum-plastic composite film.

In some embodiments, the material of the case includes a composite film formed by one or more of polypropylene (PP), polybutylene terephthalate (PBT), polybutylene succinate (PBS), nylon, polyethylene terephthalate (PET), and polyethylene (PE) and aluminum.

The pouch material has a high elongation rate, so the case is lighter, thinner and softer, which helps to improve the space utilization of the battery cell and thus increase the energy density of the battery cell. In addition, the high barrier property of aluminum can effectively reduce the penetration of water and oxygen into the battery, reduce the decomposition of the electrolyte solution and the oxidation degree of the electrode material, thereby increasing the battery life.

In some embodiments, the capacity of the battery cell at 25 °C is 95 Ah to 300 Ah.

In some embodiments, the capacity of the battery cell at 25 °C is 150 Ah to 190 Ah.

In the present application, the capacity of the battery cell has a meaning well-known in the art, and can be tested by methods known in the art. As an example, at 25 °C, the battery cell is charged to 3.65V at a charging rate of 0.5C, then charged to 0.05 C at a constant voltage of 3.65V, let stand for 10 minutes, and then discharged to 2.5V at a discharging rate of 1C. The discharge capacity of the battery cell is used as the capacity of the battery cell.

In some embodiments, at 25 °C, the capacity of the battery cell can be selected to be 95 Ah, 100 Ah, 105 Ah, 110 Ah, 115 Ah, 120 Ah, 125 Ah, 130 Ah, 135 Ah, 140 Ah, 145 Ah, 150 Ah, 155 Ah, 158 Ah, 159 Ah, 160 Ah, 161 Ah, 165 Ah, 170 Ah, 175 Ah, 178 Ah, 180 Ah, 185 Ah, 190 Ah, 200 Ah, 210 Ah, 220 Ah, 230 Ah, 240 Ah, 250 Ah, 270 Ah, 280 Ah, 290 Ah, 300 Ah or a numerical range between any two of these values.

A second aspect of the present application provides a battery apparatus, including the battery cell according to the first aspect of the present application.

The battery apparatus disclosed in the embodiments of the present application can be used in an electrical device in which a battery apparatus is used as a power source or in various energy storage systems in which a battery apparatus is used as an energy storage element. In addition to being used in a vehicle, the battery apparatus may also be used in but not limited to, a mobile phone, a tablet, a laptop, an electric toy, an electric tool, a battery vehicle, an electric vehicle, a ship, a spacecraft, and so on. Among them, the electric toy may include fixed or mobile electric toys, such as a game machine, an electric vehicle toy, an electric ship toy, and an electric airplane toy, and the like. The spacecraft may include an airplane, a rocket, a space shuttle and a spaceship, and the like.

The third aspect of the present application provides an electric apparatus using a battery apparatus as a power supply, and the electric apparatus includes at least one of the battery cell, battery module or battery pack provided by the present application. The battery cell, the battery module, or the battery pack may be used as a power source for the electrical apparatus, and may also be used as an energy storage unit for the electrical apparatus. The electrical apparatus may select the battery cell, the battery module, or the battery pack according to use requirements thereof.

FIG. 5 shows an electrical apparatus as an example. The electrical apparatus disclosed in the embodiments of the present application may be a fuel vehicle, a gas vehicle, or a new energy vehicle, and the new energy vehicle may be an all-electric vehicle, a hybrid electric vehicle, an extended range electric vehicle, etc. A battery apparatus is arranged inside the vehicle, and the battery apparatus may be arranged at the bottom, the front or the rear of the vehicle. The battery apparatus may be used to power the vehicle. For example, the battery apparatus may be used as an operating power source of the vehicle. The vehicle may further include a controller and a motor. The controller is used to control the battery apparatus to power the motor, for example, for meeting operating power demands when the vehicle is starting, navigating, and traveling. In some embodiments of the present application, the battery apparatus not only may serve as the operating power source of the vehicle, but also may serve as a driving power source of the vehicle, thus replacing or partially replacing fuel or natural gas to provide driving power for the vehicle.

A fourth aspect of the present application provides an energy storage apparatus that uses a battery apparatus as a power source. The energy storage apparatus may be, but is not limited to, an energy storage container, an energy storage cabinet, an energy storage power station, an energy storage battery pack, a portable energy storage system, etc.

### EXAMPLES

Examples of the present application will be described below. The Examples described below are illustrative and only used to explain the present application, and cannot be construed as limiting the present application. In Examples in which no specific technologies or conditions are specified, technologies or conditions described in the literature in the art or product specifications are followed. The reagents or instruments used without manufacturer indicated are all commercially available conventional products.

### Example 1

### (1). Preparation of Positive Electrode Active Material

Lithium dihydrogen phosphate, ferrous oxalate, a carbon source, titanium dioxide and vanadium pentoxide were mixed uniformly in methanol and ground to obtain a mixed raw material. Among them, the ratio of lithium dihydrogen phosphate and ferrous oxalate is such that the molar ratio of lithium to iron was 1.025:1.0; the carbon source included polyethylene glycol with a weight average molecular weight of 500, polyethylene glycol with a weight average molecular weight of 2000, and polyethylene glycol with a weight average molecular weight of 4000 in a mass ratio of 2:6:2; the particle size D₁₀ of ferrous oxalate was 6.5 μm, its particle size D₅₀ was 62 μm, and its particle size D₉₀ was 108 μm; the mass content of Fe element in ferrous oxalate was 30.5%, and the mass content of trivalent iron element was 0.03%.

The mixed raw material was ball-milled multiple times in a ball mill and demagnetized to obtain a mixed slurry. The grinding times and duration were controlled, and the particle size Dv₅₀ of the mixed slurry after grinding was 3.15 μm.

The mixed slurry was spray-dried to obtain a dry precursor powder, and the dry precursor powder had a light yellow appearance and a uniform color.

The precursor powder was placed in a sintering furnace, and heated from 25 °C to 360 °C at a rate of 2 °C/min under a nitrogen atmosphere and kept at this temperature for 3.5 hours. Then, it was heated to a second temperature of 785 °C at a rate of 5 °C/min and kept at this temperature for 10 hours. Afterwards, the temperature was lowered for cooling. Based on the total mass of the positive electrode active material, the mass content of Ti element was 1050 ppm, and the mass content of V element was 950 ppm.

The obtained material was crushed by airflow pulverization with a classification frequency of 21 Hz and a pulverization pressure of 0.54 MPa to obtain a lithium iron phosphate positive electrode active material with the surface provided with a carbon material.

The above D10, D50, D90, and Dv50 refer to the data obtained by Malvern laser scattering method.

### (2) Preparation of a Positive Electrode Plate

The above-mentioned positive electrode active material, conductive agent, and binder polyvinylidene fluoride were mixed in a solvent N-methyl pyrrolidone at a mass ratio of 94.1:1.9:3, and then a dispersant HNBR accounting for 1% by mass was added. The mixture was fully mixed in a stirring tank, stirred, and dispersed to form a positive electrode slurry; wherein the stirring included pre-stirring and main stirring, the stirring speed of the pre-stirring was lower than that of the main stirring, the revolution speed of the pre-stirring was 25 rpm, the rotation speed was 500 rpm, and the pre-stirring time was 15 minutes. After the stirring process was completed, the positive electrode slurry was transported to a coating process. The conductive agent included conductive carbon black and multi-walled carbon nanotubes at a mass ratio of 0.9:1. The conductive carbon black had a specific surface area of 80 m²/g and an oil absorption value of 180 mL/100 g. The carbon nanotubes had an average length of 20 μm and a specific surface area of 280 m²/g.

The positive electrode slurry was transferred and coated onto aluminum foil, followed by drying and hot pressing to obtain a positive electrode plate with a single-side surface density of 0.38 g/1540.25 mm² of the positive electrode film layer and a compacted density of 2.36 g/cm³. The compacted density here refers to the compacted density of the battery cell when it is fully discharged.

The hot pressing process included three stages of hot rolling, with the pressure of the hot rollers increasing sequentially to 35 tons, 55 tons, and 75 tons. The temperature of the hot rollers was maintained at 65 °C. Before the first hot rolling compaction, the electrode plate was preheated to a temperature of 50 °C.

The positive electrode plates were striped and punched into specified shapes, and the punched positive electrode plates were sorted by weight using a weighing sorting machine for stacking by a stacking machine.

Among them, in the cross-section of the positive electrode film layer along the thickness direction of the electrode plate, in the cumulative distribution curve of sphericity area of particles with a particle size R1 satisfying R1≥1000 nm, the median L_{R1A50} of the sphericity was 0.721; the median C₅₀ of graphitization degree of the positive electrode film layer was 1.11; based on the total area of particles in the cross-section of the positive electrode film layer along the thickness direction of the electrode plate, the area of the particles with a particle size R1 satisfying R1≥1000 nm accounted for 35.28%; in the cross-section of the positive electrode film layer along the thickness direction of the electrode plate, the distribution uniformity of the particles with a particle size R1 satisfying R1≥1000 nm was 1.97%; the median B₅₀ of coating value B of the positive electrode film layer was 0.441; the iron dissolution rate of the positive electrode material was 976 ppm; based on the total area of the cross-section of the positive electrode film layer along the thickness direction of the electrode plate, the area of the agglomeration region of the conductive agent accounted for 1.91%; and the porosity of the positive electrode film layer was 15.06%.

### (3) Preparation of a Negative Electrode Plate

A mixture of artificial graphite and natural graphite (weight ratio of 1:1), conductive agent (conductive carbon black), binder (styrene-butadiene rubber, SBR), and thickener (sodium carboxymethyl cellulose, CMC) was uniformly mixed at a weight percentage ratio of 96:0.5:2.0:1.5. Deionized water was then added, and the mixture was stirred and dispersed to obtain a negative electrode slurry. The negative electrode slurry was coated onto a copper foil substrate and processed through drying, compaction, slitting, and cutting to produce a negative electrode plate.

The negative electrode plates were striped and punched into specified shapes, and the punched negative electrode plates were sorted by weight using a weighing sorting machine for stacking by a stacking machine.

### (4) Separator

Polyvinylidene fluoride (PVDF) was dissolved in N-methyl pyrrolidone (NMP), stirred evenly, and polyethylene glycol (PEG) was added as a pore-forming agent, and the mixture was stirred and mixed thoroughly to obtain an adhesive layer solution. The adhesive layer solution was applied to the base film having ceramic layers on both sides, pre-volatilized at 80 °C and dried at 110 °C, and then immersed in deionized water to dissolve PEG, thereby obtaining a separator having an adhesive layer with a porous structure.

The thickness of the base film was 8 μm, the thickness of the single-side ceramic layer was 3 μm, and the thickness of the single-side adhesive layer was 1 μm.

### (5) Electrolyte Solution

In a glove box in an argon atmosphere (H₂O<0.1 ppm, O₂<0.1 ppm), organic solvents of ethylene carbonate (EC), dimethyl carbonate (DMC) and ethyl methyl carbonate (EMC) were uniformly mixed.

Lithium hexafluorophosphate was then added and dissolved in the organic solvent to make the concentration of lithium hexafluorophosphate in the electrolyte solution be 1.05 mol/L. Vinylene carbonate (VC) was then added, and the mixture was stirred uniformly to obtain the electrolyte solution of Example 1.

Among them, based on the total mass of the electrolyte solution, the mass content of dimethyl carbonate was 26%, the mass content of ethyl methyl carbonate was 43.3%, the mass content of ethylene carbonate was 17.3%, and the mass content of vinylene carbonate was 0.9%.

### (6) Preparation of Battery

The positive electrode plate, the separator and the negative electrode plate were stacked in sequence using the stacking machine, and the separator should function to isolate the positive electrode plate and the negative electrode plate to obtain a stacked type cell. The stacked type cells underwent adhesive tape application to securely wrap the cells. The stacked type cells with adhesive tape applied were placed in an outer package, which was a pouch aluminum-plastic film. The aluminum-plastic film was composed of an inner layer of polypropylene, a middle layer of aluminum foil, and an outer layer of nylon. Among them, the aluminum-plastic film outer package was formed and trimmed using a punching and forming machine to achieve the desired shape and dimension. The aluminum-plastic film was then heat-sealed to ensure that the packaging tension of the aluminum-plastic film was ≥25N/8 mm. The battery was vacuum-baked and allowed to stand, and the electrolyte solution was injected using a flat-head needle. The battery was then packaged and hot-pressed at 45 °C for 2 minutes under a pressure of 90 kg/cm², and cold-pressed at 25 °C for 2 minutes under a pressure of 90 kg/cm². Finally, after processes such as formation, vacuum exhaust, and edge trimming, a battery cell was obtained. The dimensions of the battery cell were 600 mm in the length direction, 125 mm in the width direction, and 20 mm in the thickness direction.

### Example 2

The preparation method of Example 2 was substantially the same as that of Example 1, except that in the preparation of the positive electrode active material, the second temperature was adjusted to 765 °C.

### Example 3

The preparation method of Example 3 was substantially the same as that of Example 1, except that in the preparation of the positive electrode active material, the second temperature was adjusted to 735 °C.

### Example 4

The preparation method of Example 4 was substantially the same as that of Example 1, except that in the preparation of the positive electrode active material, the carbon source was replaced by polyethylene glycol with a molecular weight of 500 and polyethylene glycol with a molecular weight of 2000 at a mass ratio of 2:8.

### Example 5

The preparation method of Example 5 was substantially the same as that of Example 1, except that in the preparation of the positive electrode active material, the carbon source was replaced by polyethylene glycol with a molecular weight of 500.

### Example 6

The preparation method of Example 6 was substantially the same as that of Example 1, except that in the preparation of the positive electrode active material, the carbon source was replaced by polyethylene glycol with a molecular weight of 2000.

### Example 7

The preparation method of Example 7 was substantially the same as that of Example 3, except that in the preparation of the positive electrode active material, the carbon source was replaced by polyethylene glycol with a molecular weight of 500 and glucose at a mass ratio of 2:8.

### Example 8

The preparation method of Example 8 was substantially the same as that of Example 1, except that in the preparation of the positive electrode plate, the coating weight was adjusted, and parameters such as the hot rolling pressure, the hot rolling temperature, the coating transfer speed, and the heating temperature before the first hot rolling compaction were adaptively adjusted so that the single-side surface density of the positive electrode film layer obtained by cold pressing is 0.43 g/1540.25 mm²; and the thickness of the battery was appropriately adjusted while keeping the numbers of positive electrode plates, separators, and negative electrode plates unchanged.

### Example 9

The preparation method of Example 9 was substantially the same as that of Example 1, except that in the preparation of the positive electrode plate, the coating weight was adjusted, and parameters such as the hot rolling pressure, the hot rolling temperature, the coating transfer speed, and the heating temperature before the first hot rolling compaction were adaptively adjusted so that the single-side surface density of the positive electrode film layer obtained by cold pressing is 0.26 g/1540.25 mm²; and the thickness of the battery was appropriately adjusted while keeping the numbers of positive electrode plates, separators, and negative electrode plates unchanged.

### Example 10

The preparation method of Example 10 was substantially the same as that of Example 1, except that parameters such as the hot rolling pressure, the hot rolling temperature, the coating transfer speed, and the heating temperature before the first hot rolling compaction were adjusted to obtain a positive electrode plate with a single-side surface density of 0.41 g/1540.25 mm² and a compacted density of 2.52 g/cm³. The compacted density here refers to the compacted density of the battery cell when it is fully discharged. Moreover, the thickness of the battery was appropriately adjusted while keeping the numbers of positive electrode plates, separators and negative electrode plates unchanged.

### Comparative Example 1

The preparation method of Comparative Example 1 was substantially the same as that of Example 3, except that in the preparation of the positive electrode active material, the carbon source was replaced by glucose.

### Comparative Example 2

The preparation method of Comparative example 2 was substantially the same as that of Example 1, except that in the preparation of the positive electrode plate, the coating weight was adjusted, and parameters such as the hot rolling pressure, the hot rolling temperature, the coating transfer speed, and the heating temperature before the first hot rolling compaction were adaptively adjusted so that the single-side surface density of the positive electrode film layer obtained by cold pressing is 0.24 g/1540.25 mm²; and the thickness of the battery was appropriately adjusted while keeping the numbers of positive electrode plates, separators, and negative electrode plates unchanged.

### Test Method

### 1. Capacity of Battery Cell

At 25 °C, the battery was charged to 3.65V at a charging rate of 0.5C of the nominal capacity of the battery cell, then charged to 0.05C at a constant voltage of 3.65V, let stand for 10 minutes, and then discharged to 2.5V at a discharging rate of 1C, and let stand for 10 minutes. The capacity C during the discharge process was calculated by the Formula C=I*t, in Ah.

### 2. Number of Cycles Corresponding to Capacity Degradation to 80%

At 25 °C, the battery was charged to 3.65V at a charging rate of 0.5C of the nominal capacity of the battery cell, then charged to 0.05C at a constant voltage of 3.65V, let stand for 10 minutes, and then discharged to 2.5V at a discharging rate of 1C, and let stand for 10 minutes. A single charge and discharge process was considered one cycle. The test continued until the battery capacity degraded to 80% of its nominal capacity, at which point the number of cycles was recorded as number of cycles@80% SOH.

### Test Results

The test results of the above Examples and Comparative examples are shown in Table 1.

TABLE 1

| | Positive electrode film layer | | | | Battery | |
|---|---|---|---|---|---|---|
| | | | L_{R1A50} in cumulative | | @80% | |
| | Single-side | | distribution curve of | Median C₅₀ | SOH | |
| | surface | Compacted | sphericity area of particles | of | (Number | |
| | density | density | with particle size R1 | graphitization | of | Capacity |
| | g/1540.25 mm² | (g/cm³) | satisfying R1 ≥ 1000 nm | degree | cycles) | (Ah) |
| Example 1 | 0.38 | 2.36 | 0.72 | 1.11 | 2107 | 160 |
| Example 2 | 0.38 | 2.36 | 0.70 | 1.02 | 2040 | 159 |
| Example 3 | 0.38 | 2.36 | 0.67 | 1.01 | 2018 | 158 |
| Example 4 | 0.39 | 2.36 | 0.72 | 1.07 | 2097 | 161 |
| Example 5 | 0.39 | 2.36 | 0.72 | 1.03 | 2075 | 160 |
| Example 6 | 0.39 | 2.36 | 0.72 | 1.06 | 2089 | 160 |
| Example 7 | 0.39 | 2.36 | 0.67 | 0.96 | 1998 | 160 |
| Example 8 | 0.43 | 2.36 | 0.72 | 1.13 | 2090 | 178 |
| Example 9 | 0.26 | 2.36 | 0.72 | 1.11 | 2118 | 95 |
| Example 10 | 0.41 | 2.52 | 0.72 | 1.13 | 2095 | 170 |
| Comparative | 0.38 | 2.36 | 0.67 | 0.93 | 1953 | 158 |
| Example 1 | | | | | | |
| Comparative | 0.23 | 2.36 | 0.72 | 1.11 | 2120 | 85 |
| Example 2 | | | | | | |

As can be seen from the comparison between Examples and Comparative examples, the battery cell includes a stacked type cell, the stacked type cell includes a positive electrode plate and a negative electrode plate, the positive electrode plate includes a positive electrode current collector and a positive electrode film layer disposed on at least one side of the positive electrode current collector, and the positive electrode film layer includes lithium-containing transition metal phosphate particles with at least part of the surface provided with a carbon material; when the battery cell is fully discharged, a compacted density of the positive electrode plate is 2.3 g/cm³ to 2.6 g/cm³; a single-side surface density of the positive electrode film layer is 0.25 g/1540.25 mm² to 0.45 g/1540.25 mm², in a cross-section of the positive electrode film layer along a thickness direction of the positive electrode plate, in a cumulative distribution curve of sphericity area of particles with a particle size R1 satisfying R1≥1000 nm, L_{R1A50} is 0.6-0.8; and in a cumulative distribution curve of graphitization degree C value of the positive electrode film layer obtained in a surface scanning mode of a laser microscopic confocal Raman spectrometer, the median C₅₀ of the graphitization degree is 0.95-1.20, so the battery cell can maintain good capacity while improving the cycle stability of the battery during long cycles.

From the comparison between Examples 1-3, it can be seen that in the cross-section of the positive electrode film layer along the thickness direction of the positive electrode plate, in the cumulative distribution curve of sphericity area of particles with a particle size R1 satisfying R1≥1000 nm, L_{R1A50} is 0.65-0.75, which is within the range of 0.67-0.72, and the battery cell has good long-cycle stability.

From the comparison between Example 1, Examples 3-6, and Example 7, it can be seen that in the cumulative distribution curve of graphitization degree C value of the positive electrode film layer obtained in the surface scanning mode of the laser microscopic confocal Raman spectrometer, the median value C₅₀ of the graphitization degree can be further selected to be 1.01-1.13, which helps to further improve the long-cycle stability of the battery cell.

From the comparison between Example 1 and Examples 8-10, it can be seen that the single-side coating surface density of the positive electrode film layer is further within the range of 0.35 g/1540.25 mm² to 0.4 g/1540.25 mm², which helps to further balance the capacity and the long-cycle stability of the battery.

It should be noted that the present application is not limited to the aforementioned implementations. The above embodiments are only examples, and embodiments that have the same composition and exert the same effect as the technical ideas within the scope of the technical solution of the present application are included in the technical scope of the present application. In addition, without departing from the scope of the main intention of the present application, various modifications that can be conceived by those skilled in the art for the implementations, and other forms constructed by combining some of the constituent elements of the implementations are also included within the scope of the present application.

1. A battery cell, wherein the battery cell comprises a stacked type cell, the stacked type cell comprises a positive electrode plate and a negative electrode plate, the positive electrode plate comprises a positive electrode current collector and a positive electrode film layer disposed on at least one side of the positive electrode current collector, and the positive electrode film layer comprises lithium-containing transition metal phosphate particles with at least part of a surface provided with a carbon material;
when the battery cell is fully discharged, a compacted density of the positive electrode plate is 2.3 g/cm³ to 2.6 g/cm³;
a single-side surface density of the positive electrode film layer is 0.25 g/1540.25 mm² to 0.45 g/1540.25 mm²;
in a cross-section of the positive electrode film layer along a thickness direction of the positive electrode plate, in a cumulative distribution curve of sphericity area of particles with a particle size R1 satisfying R1≥1000 nm, L_{R1A50} is 0.6-0.8, wherein L_{R1A50} is determined from a scanning electron microscope (SEM) image of the cross-section, the particle size R1 is a Feret diameter, a sphericity L of each particle is a Round parameter; and L_{R1A50} is a sphericity L at 50% cumulative area of at least 1000 particles satisfying R1≥1000 nm; and
in a cumulative distribution curve of graphitization degree C value of the positive electrode film layer obtained in a surface scanning mode of a laser microscopic confocal Raman spectrometer, a median C₅₀ of the graphitization degree is 1.01-1.20; and, wherein the graphitization degree C value is I_{G}/I_{D}, I_{G} represents an intensity of G-band of a Raman spectrum at 1580±100 cm⁻¹, and I_{D} represents an intensity of D-band of the Raman spectrum at 1350±100 cm⁻¹.

2. The battery cell according to claim 1, wherein in the cross-section of the positive electrode film layer along the thickness direction of the positive electrode plate, in the cumulative distribution curve of sphericity area of particles with a particle size R1 satisfying R1≥1000 nm, L_{R1A50} is 0.65-0.75.

3. The battery cell according to claim 1, wherein a single-side thickness H of the positive electrode film layer is 70 μm to 120 μm.

4. The battery cell according to claim 1, wherein based on a total area of particles in the cross-section of the positive electrode film layer along the thickness direction of the electrode plate, the area of particles with a particle size R1 satisfying R1≥1000 nm accounts for 12% to 50%; and/or
in the cross-section of the positive electrode film layer along the thickness direction of the electrode plate, a distribution uniformity of particles with a particle size R1 satisfying R1≥1000 nm is less than or equal to 5%.

5. The battery cell according to claim 1, wherein in a cumulative distribution curve of coating value B of the positive electrode film layer obtained in the surface scanning mode of the laser microscopic confocal Raman spectrometer, a median B₅₀ of the coating value is 0.30-0.60, wherein the coating value B is I_{P}/I_{D}, I_{P} represents an intensity of P-band of a Raman spectrum at 948±100 cm⁻¹, and I_{D} represents an intensity of D-band of the Raman spectrum at 1350±100 cm⁻¹.

6. The battery cell according to claim 1, wherein the lithium-containing transition metal phosphate particle in the positive electrode film layer comprises a component represented by the following general formula:
LiₘFeₓP_{y}OⱼQ_{q} Formula I,
wherein Q comprises one or more of Al, Na, K, Mg, Cu, Mn, Cr, Zn, Pb, Ca, Co, Ni, Sr, Nb, V, Ti, B, S, Si, N, F, Cl and Br; 0.8≤m≤1.15, 0.9≤x≤1, 0.95≤y≤1, 3.5≤j≤4, and 0≤q≤0.1.

7. The battery cell according to claim 6, wherein an iron dissolution rate of a positive electrode material is 658 ppm to 1921 ppm.

8. The battery cell according to claim 6, wherein a mass content of titanium element is 500 ppm to 8000 ppm.

9. The battery cell according to claim 6, wherein a mass content of vanadium element is 500 ppm to 5000 ppm.

10. The battery cell according to claim 1, wherein a porosity of the positive electrode film layer is 14% to 28%.

11. The battery cell according to claim 1, wherein the positive electrode film layer further comprises a conductive agent, and based on a total area of the cross-section of the positive electrode film layer along the thickness direction of the electrode plate, the area of an agglomeration region of the conductive agent accounts for 0.5% to 2.5%.

12. The battery cell according to claim 11, wherein the conductive agent comprises carbon nanotubes, the carbon nanotubes comprise one or more of single-walled carbon nanotubes, few-walled carbon nanotubes, and multi-walled carbon nanotubes.

13. The battery cell according to claim 11, wherein the agglomeration region of the conductive agent further comprises carbon nanotubes and conductive carbon black, wherein based on a mass of the positive electrode film layer, a mass content C₁ of the carbon nanotubes satisfies: 0<C1≤2.5%, and a mass content C₂ of the conductive carbon black satisfies: 0<C2≤2.5%.

14. The battery cell according to claim 1, wherein the positive electrode film layer further comprises a dispersant, and the dispersant comprises hydrogenated nitrile butadiene rubber (HNBR), wherein a mass content of the dispersant is 0.5% to 2% based on a mass of the positive electrode film layer.

15. The battery cell according to claim 1, wherein the battery cell further comprises a separator arranged between the positive electrode plate and the negative electrode plate, and the separator comprises a base film as well as ceramic layers arranged on both sides of the base film and an adhesive layer arranged on the side of at least one ceramic layer away from the base film, the adhesive layer being a continuous layer with a porous structure and comprising a vinylidene fluoride-based polymer, wherein the separator satisfies at least one of the following conditions:
(1) the thickness of the base film is 7-9 μm;
(2) a single-side thickness of the ceramic layer is 2-4 μm;
(3) the single-side thickness of the adhesive layer is 1-5 μm.

16. The battery cell according to claim 1, wherein the positive electrode film layer is provided with a primer layer at a bottom region close to the positive electrode current collector, and the primer layer satisfies at least one of the following conditions:
(1) the primer layer comprises a conductive agent and a binder, wherein the conductive agent comprises carbon nanotubes and conductive carbon black, and the binder comprises polyvinylidene fluoride (PVDF); and
(2) the thickness of the primer layer is 0.5 μm to 5 μm.

17. The battery cell according to claim 1, wherein the battery cell comprises a case, the stacked type cell is accommodated in the case, a dimension of the case in a length direction is L₁, a dimension of the case in a width direction is W₁, and a dimension of the case in a thickness direction is H₁, wherein 450 mm≤L₁≤1300 mm, 100 mm≤W₁≤150 mm, and 14 mm≤H₁≤22 mm, wherein the material of the case is a pouch material, and the pouch material comprises an aluminum-plastic composite film, polybutylene terephthalate (PBT), polybutylene succinate (PBS), nylon, polyethylene terephthalate (PET), and polyethylene (PE) and aluminum.

18. The battery cell according to claim 1, wherein a capacity of the battery cell at 25 °C is 95 Ah to 300 Ah.

19. A battery apparatus, comprising the battery cell according to claim 1.

20. An energy storage apparatus, wherein the energy storage apparatus comprises the battery apparatus according to claim 19, the battery apparatus being used for storing electrical energy.
